(19) United States
(12) Patent Application Publication
(10) Pub. No.: US 2011/0091283 A1
(43) Pub. Date: Apr. 21, 2011

(54) OXIDATION OF ENVIRONMENTAL CONTAMINANTS WITH MIXED VALENT MANGANESE OXIDES

(75) Inventors: Steven Suib, Storrs, CT (US); Lisa Stafford, Storrs, CT (US); Hui Huang, Yushan City (CN); George E. Hoag, Bloomfield, CT (US); John B. Collins, Bloomfield, CT (US)

(73) Assignees: University of Connecticut, Farmington, CT (US); VeruTEK Technologies, Inc., Bloomfield, CT (US)

(21) Appl. No.: 12/903,866

(22) Filed: Oct. 13, 2010

Related U.S. Application Data
(60) Provisional application No. 61/251,458, filed on Oct. 14, 2009.

(51) Int. Cl. B09C 1/08; B01J 29/00; B01J 31/02; B01J 31/06

(52) U.S. Cl. 405/128.75; 502/324; 502/150; 502/172; 502/167; 502/159

(57) ABSTRACT

Methods and compositions for reduction of contaminants using manganese-based octahedral molecular sieves.

### CROSS-REFERENCE TO RELATED APPLICATION

This application claims priority to U.S. Provisional Application No. 61/251,458 filed Oct. 14, 2009, the entire contents of which is hereby incorporated by reference.

This invention, or aspects of it, was made using U.S. Government support under DOE FRS 522664. The government has certain rights in this invention.

### FIELD OF THE INVENTION

The present invention relates to methods and compositions for remediating soil and groundwater. For example, the present invention relates to methods and compositions for removing contaminants from soil, groundwater and wastewater using manganese-based octahedral molecular sieves.

### BACKGROUND

Zeolites and zeolite-like materials constitute a well-known family of molecular sieves. These materials are tetrahedral coordinated species with TO₄ tetrahedra (in which T is silicon, aluminum, phosphorus, boron, beryllium, gallium, etc.) serving as the basic structural unit. Through secondary building units, a variety of frameworks with different pore structures can be constructed. Like tetrahedra, octahedra can also serve as the basic structural units of molecular sieves.

Manganese oxide octahedral molecular sieves (OMS) possessing mono-directional tunnel structures constitute a family of molecular sieves wherein chains of MnO₆ octahedra share edges to form tunnel structures of varying sizes. Such materials have been detected in samples of terrestrial origin and porous manganese oxide natural materials are also found as manganese nodules. These materials when dredged from the ocean floors have been used as excellent adsorbents of metals such as from electroplating wastes and have been shown to be excellent catalysts. The natural systems are often found as mixtures, are poorly crystalline, and have incredibly diverse compositions due to exposure to various aqueous environments in nature. Such exposure allows ion exchange to occur.

Such materials have also been produced synthetically. Rationale for synthesis of novel OMS materials is related to the superb conductivity, microporosity, and catalytic activity of the natural materials. Variable pore size materials have been synthesized using structure directors and with a variety of synthetic methodologies. Transformations of tunnel materials with temperature and in specific atmosphere have recently been studied with in situ synchrotron methods. Conductivities of these materials appear to be related to the structural properties of these systems with more open structures being less conductive. Catalytic properties of these OMS materials have been shown to be related to the redox cycling of various oxidations states of manganese such as Mn²⁺, Mn³⁺, and Mn⁴⁺. Concepts of nonstoichiometry, defects, oxygen vacancies, and intermediates are fundamental to many of the syntheses, characterization, and applications such as fuel cells, catalysis, adsorption, sensors, batteries, and related applications.

Current environmental remediation technologies are inadequate. Environmental contaminants can often be destroyed by natural processes (Lovely, Nat. Rev. Microbiol., vol. 1, no. 1, pp. 35-44, October 2003). Bioremediation uses microbes to oxidize environmental pollutants. Microbes are problematic as they are sensitive to changes in both temperature and pH. The timescale of bioremediation is also long and varies as a function of local conditions. In addition, microbes not indigenous to a particular area are often introduced to battle contamination. This is undesirable from an ecological viewpoint. Furthermore, bioremediation projects have been characterized by an inability to meet cleanup goals and competition from native bacterial populations (Lehr, ed., Wiley's Remediation Technologies Handbook: Major Contaminant Chemicals and Chemical Groups, Wiley-Interscience, pp. 1136-1137, 2004.)

Fenton's reagent generates the diffusion-limited hydroxyl radical through the mixture of iron salts and hydrogen peroxide. The potent hydroxyl radical oxidizes everything in its path, including natural organic matter present in the subsurface (Villa et al., Chemosphere, vol. 71, pp. 43-50, 2008). This removal leaves the soil more vulnerable to future pollution as soil has been robbed of its inherent ability for natural microbial removal of contaminants. High reactivity also decreases the sphere of influence at the injection site. Hydrogen peroxide is expensive, difficult to store, and unstable. Furthermore, radical scavengers such as carbonates in the subsurface, deactivate the effectiveness of Fenton's reagent (Watts et al., Journal of Environmental Science and Engineering, pp. 612-622, April 2005).

Nanoscale zero-valent iron (nZVI) is another widely popular remediation technology in current use. nZVI degrades rapidly as a function of time and therefore must be freshly prepared prior to use.

### SUMMARY OF THE INVENTION

The inventive method may involve forming a mutually compatible combination of manganese-based octahedral molecular sieves (OMS), contaminant, and medium effective to degrade the contaminant, optionally including an oxidant, and a surfactant and/or cosolvent. The medium may comprise solid and/or fluid components. The OMS may be introduced to the medium, or vice versa, depending on the medium. In either case, the method comprises bringing the sieves into contact with the contaminated medium or bringing the contaminated medium into contact with the sieves, putting the OMS in contact with the contaminant long enough for the OMS to react with oxygen or an oxidant to destroy contaminants. For solid media, the method may comprise introducing the OMS to the medium to contact the contaminant. For example, a mutually compatible combination may include a contaminated subsurface, e.g. soil and groundwater contaminated, e.g., by non-aqueous phase liquids (NAPLs), where the OMS and other compatible and effective components are introduced to the subsurface and allowed to react with and destroy the contaminant. Another example is introducing OMS to contaminated soil ex situ. The combination may also include a surfactant and/or cosolvent which is added to the medium to promote contaminant solubility and mobilization, and/or to condition the OMS, in a mutually compatible and effective formulation. For fluid media containing contaminants, the method may comprise forming an OMS-containing barrier, e.g. a solid substrate or semisolid formulation, and flowing the medium to the barrier to contact and be destroyed, e.g. oxidized by, the OMS. For example, the OMS can be bound to or incorporated into a permeable or impermeable reactive barrier, including, for example, a gel. The fluid may be subsurface groundwater or air.

This application presents embodiments of an invention which include methods and compositions for reducing the amount of a contaminant in a medium by combining manganese-based octahedral molecular sieves with the medium under conditions effective to degrade the contaminant, wherein the contaminated medium comprises solid material and the sieves are introduced to the medium, or the contaminated medium is fluid and the sieves are incorporated into a solid reactive barrier that is contacted by the medium.

In some embodiments the medium comprises water and an oxidant, and the contaminant is an organic compound. In other embodiments, the manganese-based octahedral molecular sieves may have specific shapes or sizes, for example, 2×2 tunnel structures, and may reduce the amount of contaminant in specific media, for example in contaminated soil, groundwater or wastewater. In some embodiments, the contaminant is a non-aqueous phase liquid.

Manganese-based octahedral molecular sieves may be combined with a surfactant and/or cosolvent. These embodiments may be used for selectively treating target contaminants, for example, non-aqueous phase liquids.

Other embodiments employ specific oxidants, for example, dissolved O₂, and oxidize an organic contaminant catalytically.

Manganese-based octahedral molecular sieves may be incorporated into a reactive barrier. The reactive barrier may be permeable or impermeable.

In other embodiments, manganese-based octahedral molecular sieves may be coated through adsorption processes with surfactants or surfactant-cosolvent mixtures to enable microemulsion catalysis of immiscible phase organic contaminants.

Manganese-based octahedral molecular sieves may be coated through adsorption processes with surfactants or surfactant-cosolvent mixtures to enable more effective and efficient transport of the manganese-based octahedral molecular sieves though groundwater.

Manganese-based octahedral molecular sieves may be doped with transition or noble metals or complexes containing transition or noble metals to increase catalytic activity manganese-based octahedral molecular sieves alone or with oxidants added.

A method for reducing the amount of a contaminant in a soil according to the invention includes introducing manganese-based octahedral molecular sieves and a surfactant into a subsurface, ground surface or above-ground formation, structure, or container containing the soil, allowing the surfactant to solubilize or desorb the contaminant, and allowing the manganese-based octahedral molecular sieves to oxidize the solubilized contaminant in the subsurface, so that the amount of the contaminant in the soil is substantially reduced. In other embodiments, an oxidant may also be introduced. The overall rate of oxidization of the contaminant is controlled to a predetermined value and the overall rate of solubilization of the contaminant is controlled to a predetermined value by selecting the oxidant, surfactant, and antioxidant and adjusting the concentrations of surfactants, oxidants, and antioxidants. Thus, as the user of the method chooses, the rate of oxidation of the contaminant is greater than, less than, or equal to the rate of solubilization of the contaminant.

Embodiments of the invention include compositions comprising a synthetic manganese-based octahedral molecular sieve, soil, oxidant and a contaminant, wherein the contaminant is an organic compound. In other embodiments, the compositions further comprise a surfactant and/or cosolvent.

Other embodiments include compositions comprising a synthetic manganese-based octahedral molecular sieve, wastewater, and an organic chemical, and the compositions may further comprise a surfactant and/or cosolvent.

The invention encompasses compositions comprising manganese-based octahedral molecular sieves and a diluent. Such compositions may be used, for example, for the formation of reactive barriers. Other embodiments of the invention include reactive barriers comprising manganese-based octahedral molecular sieve. In further embodiments, the reactive barriers are permeable or impermeable.

In an embodiment according to the invention, a composition includes at least one citrus terpene, at least one nonionic surfactant, manganese-based octahedral molecular sieves and water. The nonionic surfactant can be ethoxylated soybean oil, ethoxylated castor oil, ethoxylated coconut fatty acid, and/or amidified, ethoxylated coconut fatty acid.

A method for reducing the initial mass of a contaminant in a volume of soil, according to the invention, includes introducing a volume of a solution including an oxidant and a volume of a solution including a surfactant into a substrate containing the soil. At least 40% of the initial mass of contaminant is eliminated from the volume of soil. No more than 5% of the combined volume of the solution comprising the oxidant and the volume of the solution comprising the surfactant is extracted from the soil.

### BRIEF DESCRIPTION OF THE DRAWINGS

FIG. 1 shows structures of example OMS materials; OMS-2 (1A) and OMS-1 (1B).

FIG. 2 show the XRD Pattern of K-OMS-2. 2(a) K-OMS-2 prior to sonication; 2(b) K-OMS-2 after 15 minutes sonication; 2(c) K-OMS-2 after 15 minutes sonication and reaction with TCP.

FIG. 3 shows the TEM Image of K-OMS-2 with unique bamboo morphology.

FIG. 4 shows TEM image of K-OMS-2 following 15 minutes of sonication.

FIG. 5A and FIG. 5B show the decomposition of example contaminant, 2,4,6-trichlorophenol, by K-OMS-2 with 10 g/L VeruSOL-3 surfactant.

FIG. 6A and FIG. 6B show the decomposition of example contaminant, 2,4,6-trichlorophenol, by K-OMS-2 with 15 g/L VeruSOL-3 surfactant.

FIG. 7A and FIG. 7B show the decomposition of example contaminant, 2,4,6-trichlorophenol, by K-OMS-2 with 20 g/L VeruSOL-3 surfactant.

FIG. 8A and FIG. 8B show the decomposition of example contaminant, 2,4,6-trichlorophenol, by K-OMS-2 with 25 g/L VeruSOL-3 surfactant.

FIG. 9 shows the UV-Vis Absorption Spectrum of the reaction solution both before and after addition of K-OMS-2 for degradation of TCP. Note that the solution is diluted 100 times prior to addition of KOMS-2, whereas the reaction solution after addition of K-OMS-2 is not diluted, indicating complete degradation of TCP.

FIG. 10 shows the FTIR Spectrum of pure TCP compared to K-OMS-2 after the six-hour oxidation of TCP. One partial oxidation product, 1,2-Dihydroxybenzene, is adsorbed to the KOMS-2 after reaction. This is evidenced by the CC stretching vibrations characteristic of 1,2-Dihydroxybenzene at 1623, 1581, and 1382 cm⁻¹ together with the peak at 1150 cm⁻¹ which is typical of a 1,2-Disubstituted Benzene.

FIG. 11 shows the oxidation of solubilized heating oil with KOMS-2 added to catalyze hydrogen peroxide and KOMS-2 alone.

FIG. 12 shows one of five replicate runs with triplicate analysis of particle size measurements made with a Malvern Zetasizer Nano series. FIG. 12A shows the particle size of Verusol-3 surfactant in solution at 5 g/L. FIG. 12B shows the particle size of KOMS-2 at 0.556 g/L.

FIG. 13 shows the effects of Verusol-3 surfactant concentration on KOMS-2 particle size in a 0.556 g/L KOMS-2 suspension.

FIG. 14 shows a comparison of Verusol-3 surfactant interfacial tension measurements with and without KOMS-2.

FIG. 15 shows the effects of Verusol-3 surfactant concentration on KOMS-2 Zeta potential in a 0.556 g/L KOMS-2 suspension.

FIG. 16 shows particle size measurements made with a Malvern Zetasizer Nano series from Malvern Instruments. FIG. 16A shows particle size distribution for KOMS-2 (0.556 g/L) with Verusol-3 surfactant (5 g/L). FIG. 16B shows particle size distribution for KOMS-2 (0.556 g/L) with Verusol-3 surfactant (10 g/L). FIG. 16C shows particle size distribution for KOMS-2 (0.556 g/L) with Verusol-3 surfactant (25 g/L).

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art will recognize that other equivalent parts can be employed and other methods developed without parting from the spirit and scope of the invention. As described herein, all embodiments or subcombinations may be used in combination with all other embodiments or subcombinations, unless mutually exclusive. All references cited herein are incorporated by reference as if each had been individually incorporated. For example, international application number PCT/US2007/007517, filed on Mar. 27, 2007 and published as WO2007/126779 on Nov. 8, 2007 and U.S. patent application Ser. No. 12/068,653, filed on Feb. 8, 2008 and published as US 2008-0207981A1 on Aug. 28, 2008 are hereby incorporated by reference.

This application presents embodiments of an invention which include methods and compositions for reducing the amount of a contaminant in a medium using manganese-based octahedral molecular sieves (OMS). The method may involve forming a mutually compatible combination of OMS, contaminant, and medium effective to degrade the contaminant, optionally including an oxidant, and a surfactant and/or cosolvent. The medium may include solid and/or fluid components. The OMS may be introduced to the medium, or vice versa, depending on the medium. The OMS may be fixed in place, for example, as part of a reactive barrier, or mobile, i.e., moving within the medium, to destroy contaminants, depending on the medium. The medium may include fixed components, i.e., the medium contains solid materials that do not move, fluid components, i.e. components that move freely, such as water or air, or both fixed and fluid components, such as a contaminated subsurface having both soil and groundwater. In any case, the method includes bringing the sieves into contact with the contaminated medium or bringing the contaminated medium into contact with the sieves. In other words, the method involves putting the OMS in contact with the contaminant long enough for the OMS to react with and degrade a contaminant, or long enough for OMS to react with oxygen or an oxidant to oxidize and/or decompose a contaminant. In some instances, OMS may react directly with the contaminant and with oxygen or an oxidant to degrade contaminants by a combination of both mechanisms. For a medium including solid materials, the method may include introducing the OMS to the medium to contact the contaminant. For example, a mutually compatible combination may include a contaminated subsurface, e.g. soil and groundwater contaminated, for example, by non-aqueous phase liquids (NAPLs), where the OMS and other compatible and effective components are introduced to the subsurface and allowed to react with and destroy the contaminant in situ. Another example is introducing OMS to contaminated soil ex situ. The combination may also include a surfactant and/or cosolvent which is added to the medium to promote contaminant solubility and mobilization, and/or to condition the OMS, in a mutually compatible and effective formulation. For contaminated fluid media, the method may comprise forming an OMS-containing barrier, e.g. a solid substrate or semisolid formulation, and flowing the medium to the barrier to contact the OMS and oxidize and/or decompose or destroy the contaminants. For example, the OMS can be bound to or incorporated into a permeable or impermeable reactive barrier, including, for example, a gel. The fluid may be subsurface groundwater or air.

In some embodiments, a contaminant is an organic compound, the amount of which is reduced in concentration by the action of the OMS, and may also be called an organic contaminant. For example, the organic compound can be a carbon-containing compound other than carbon dioxide. The organic compound or contaminant may be an organic contaminant of concern (COC) for water security as defined by the US Environmental Protection Agency (EPA). Contaminants of concern for water security are those contaminants that may or may not be regulated, but could pose a significant threat to public health if accidentally or intentionally introduced into drinking water. In some embodiments, the contaminant is a non-aqueous phase liquid (NAPL). Examples of contaminants include volatile organic compounds, semi-volatile organic compounds, non-aqueous phase liquids, chlorinated solvents, dense nonaqueous phase liquids, light nonaqueous phase liquids, polycyclic aromatic hydrocarbons, pesticides, polychlorinated biphenyls, benzene, toluene, ethyl benzene, xylene, halogenated hydrocarbons, petroleum range hydrocarbons and combinations thereof.

“Contaminants” encompasses any organic compound present in a location that, by its presence, diminishes the usefulness of the location for productive activity or natural resources, or would diminish such usefulness if present in greater amounts or if left in the location for a length of time. The location may be subsurface, on land, in or under the sea or in the air. “Contaminant” thus can encompass trace amounts or quantities of such a substance. Examples of productive activities include, without limitation, recreation; residential use; industrial use; habitation by animal, plant, or other life form, including humans; and similar such activities. Examples of natural resources are aquifers, wetlands, sediments, soils, plant life, animal life, and ambient air quality. As used herein “contaminated” means containing one or more contaminant. Contaminated soil, contaminated groundwater, or contaminated wastewater may each include one or more contaminants.

In various embodiments of the present invention, an amount of contaminant is reduced in a medium, where the medium comprises water and an oxidant, and where the contaminant is an organic compound.

In the context of this invention, the water in the medium may be purified laboratory grade water, groundwater, or may be contaminated water such as wastewater or contaminated groundwater.

As used herein, “wastewater” is any water that has been adversely affected in quality by anthropogenic influence. It comprises liquid waste discharged by domestic residences, commercial properties, industry, and/or agriculture and can encompass a wide range of potential contaminants and concentrations.

As used herein, “groundwater” is water located beneath the ground surface. Groundwater also includes natural water removed from the ground, but without distillation or osmotic purification.

In some embodiments, the medium further comprises soil. In some embodiments, therefore, the method is practiced in a subsurface where soil is present in the medium. In other embodiments, the medium may include soil which has been removed from the ground, for instance, contaminated soil which has been removed for treatment. In other embodiments, the soil may be added to a container or column, for instance, for laboratory testing.

As used herein, an “oxidant” is a chemical or agent that removes electrons from a compound or element, increases the valence state of an element, or takes away hydrogen by the addition of oxygen. In this text, the term “oxidant” includes all oxidizing compounds or compounds that decompose or react to form an oxidizing compound. For example, the term “oxidant” includes solid, liquid, or gaseous compounds that can decompose to liberate oxygen or an oxidizing species. For example, the term “oxidant” includes compounds such as persulfates, percarbonates, peroxides, hydrogen peroxide, and permanganates. For example, the term “oxidant” also includes oxidizing gases, such as oxygen, ozone, and air. For example, the term “oxidant” also includes dissolved gases, such as oxygen or ozone dissolved in an aqueous or non-aqueous liquid.

In some embodiments, the OMS may have a 2×2 tunnel structure (OMS-2). In some specific embodiments, the OMS is K-OMS-2.

The oxidant may be present in the medium naturally, i.e. as dissolved oxygen or other oxidant. In other embodiments, the oxidant may be added to the medium. In such embodiments, the oxidant may be introduced into the medium before the introduction of the OMS, at the same time as the OMS, or after introduction of the OMS. The oxidant may be introduced as a mixture with OMS or separately.

The OMS may be coated with a surfactant or a surfactant-cosolvent mixture to modify the surface properties of the OMS making OMS easier to transport through groundwater in soils.

The OMS may be coated with a surfactant or a surfactant-cosolvent mixture to provide a unitary mixture to desorb and solubilize or emulsify organic contaminants and to catalytically oxidize the desorbed and solubilize or emulsify in a surfactant-OMS particle matrix.

In some embodiments, the oxidant is only dissolved oxygen. In other words, no other oxidants are added to the medium. In other embodiments, where the oxidant is added to the medium, the oxidant is not ozone, permanganate, persulfate, peroxide or percarbonate compounds. In other embodiments, the only oxidant added to the medium may be O₂ in the form of air, oxygen gas, or dissolved oxygen. In other embodiments, the added oxidant is a persulfate or peroxide compound. As used here, a permanganate, persulfate, peroxide or percarbonate compound includes any salt or form of permanganate, persulfate, peroxide or percarbonate, such as potassium permanganate, sodium persulfate or hydrogen peroxide.

The OMS may oxidize the organic compound catalytically. In other words, the OMS is not consumed, or is regenerated in the process of the oxidation reaction, and may be used to oxidize at least one more organic compound after the first oxidation reaction occurs. One possible explanation of the catalytic process includes a process where an organic compound binds or adsorbs to the surface of the OMS, which oxidizes the organic compound. The oxidized compound then separates from the OMS which then has an oxygen deficiency or vacancy. Oxygen (O₂) may then ‘heal’ the catalyst by correcting the oxygen deficiency or filling the oxygen vacancy, allowing the OMS to perform another oxidation. Other oxidants may function to ‘heal’ the catalyst either directly, or by supplying a source of O₂. In other possible mechanisms, the OMS catalytically “activates” the oxidant, i.e. oxygen (O₂), persulfate or hydrogen peroxide, to produce reactive peroxy species or free radicals, which oxidize the organic contaminant. For example, in some possible mechanisms the OMS acts to produce reactive peroxy species, which may oxidize organic contaminants, or produce free radicals. In other potential mechanisms, the OMS may catalytically activate peroxides or persulfates to produce free radicals.

In some embodiments, the medium is a contaminated zone. In an embodiment of the invention, the contaminated zone to be treated can be the subsurface. Alternatively, the contaminated zone to be treated can be above ground, for example, in treatment cells, tanks, windrows, or other above-ground treatment configurations.

The subsurface can include any and all materials below the surface of the ground, for example, groundwater, soils, rock, man-made structures, naturally occurring or man-made contaminants, waste materials, or products. Knowledge of the distribution of hydraulic conductivity in the soil and other physical hydrogeological subsurface properties, such as hydraulic gradient, saturated thickness, soil heterogeneity, and soil type is desirable to determine the relative contribution of downward vertical density driven flow to normal advection in the subsurface.

The introduced compositions may be applied to the subsurface using injection wells, point injection systems, such as direct push or other hydraulic or percussion methods, trenches, ditches, and by using manual or automated methods.

The OMS may be incorporated into a reactive barrier. A reactive barrier is a barrier comprising a reactive material which performs the function of reducing a contaminant. Reactive barriers may be impermeable to prevent a contaminant from spreading beyond a particular area. In this case, the OMS may be incorporated into the reactive barrier on the contaminated side, and function to reduce the amount of contamination at a remediation site. Reactive barriers may also be water permeable, allowing water to flow through the barrier. As the contaminated water flows through the barrier, the reactive materials in the barrier reduce the amount of contaminants. A reactive barrier may be used to define particular zones.

The method may further includes introducing a surfactant and/or cosolvent into the medium. In some embodiments, the surfactant and/or cosolvent are introduced into the medium to achieve a concentration of surfactant greater than the critical micelle concentration. In other embodiments, the surfactant and/or cosolvent are introduced into the medium to achieve a concentration between about 0.1 g/L and about 100 g/L. In further embodiments, the surfactant and/or cosolvent are introduced into the medium to achieve a concentration between about 1 g/L and about 10 g/L. In other embodiments, the method further comprises optimizing the hydrophile/lipophile (HLB) ratio of a surfactant or HLB ratios of a mixture of surfactants introduced in order to maximize the solubility of the contaminant. In some embodiments, the surfactant and/or cosolvent are biodegradable and/or plant derived.

Embodiments of the invention include methods for reducing the initial mass of a contaminant in a volume of soil, comprising introducing a manganese-based octahedral molecular sieve and surfactant into a substrate containing the soil. At least 40%, at least 50%, at least 70% or at least 90% of the initial mass of contaminant is eliminated from the volume of soil and no more than 20%, no more than 10%, or no more than 5% of the combined amount of the manganese-based octahedral molecular sieves and surfactant is extracted from the soil.

Specific embodiments include methods where the manganese-based octahedral molecular sieve and the surfactant are introduced as a mixture into the soil.

The invention includes methods for reducing the concentration of a contaminant in a soil, comprising introducing manganese-based octahedral molecular sieves and a surfactant into a ground surface or above-ground formation, structure, or container containing the soil; allowing the surfactant to solubilize or desorb the contaminant; and allowing the manganese-based octahedral molecular sieves to oxidize the solubilized contaminant, so that the amount of the contaminant in the soil is substantially reduced. As used here, “substantially reduced” means that the amount of the contaminant is reduced by at least 20%, at least 40%, at least 50%, at least 70%, or at least 90% of the initial amount.

The term “solubilize” as used herein can refer to, for example, one or more of incorporating a contaminant in the aqueous phase, forming a molecular scale mixture of contaminant and water, incorporating contaminant at a micellar interface, and incorporating contaminant in a hydrophobic core of a micelle.

Embodiments of the invention also include compositions comprising a synthetic manganese-based octahedral molecular sieve, soil, oxidant and a contaminant, wherein the contaminant is an organic compound. In other embodiments, the compositions further comprise a surfactant and/or cosolvent.

Other embodiments include compositions comprising a synthetic manganese-based octahedral molecular sieve, wastewater, and an organic chemical. As used herein, “wastewater” is any water that has been adversely affected in quality by anthropogenic influence. It comprises liquid waste discharged by domestic residences, commercial properties, industry, and/or agriculture and can encompass a wide range of potential contaminants and concentrations. In other embodiments, the compositions further comprise a surfactant and/or cosolvent.

Other embodiments include compositions comprising a synthetic manganese-based octahedral molecular sieve and a diluent. Such compositions may be used, for example, for the formation of reactive barriers. The diluent may be, for example, a solid phase diluent. In some specific embodiments, the solid phase diluent is, for example, sand or powdered or granulated activated carbon. These compositions may be used, for example, to create permeable reactive barriers. Other embodiments include compositions where the solid phase diluent is a polymer or polymer precursors. In specific examples, the polymer may be, for example, guar, polyphenols, polyacrylic acid, or a biopolymer, e.g. chitosan. These compositions may be used, for example for the preparation of permeable or impermeable barriers depending on the type of polymer.

Other embodiments of the invention include reactive barriers comprising manganese-based octahedral molecular sieve. In further embodiments, the reactive barriers are permeable or impermeable to water.

The reactive barrier may be an air filter and associated materials. Such materials may be used to remove organic contaminants from the air.

Specific embodiments include compositions including at least one citrus terpene, at least one nonionic surfactant, manganese-based octahedral molecular sieves and water. The nonionic surfactant can be ethoxylated soybean oil, ethoxylated castor oil, ethoxylated coconut fatty acid, an amidified, ethoxylated coconut fatty acid, an alkyl polyglucoside or an alkyl polyglucoside-based surfactant, a decyl polyglucoside or an alkyl decylpolyglucoside-based surfactant.

In some embodiments, the surfactant and/or cosolvent are biodegradable and/or plant derived. In some embodiments, the surfactant and/or cosolvent includes blends of biodegradable citrus-based solvents (for example, d-limonene) and degradable or biodegradable surfactants derived from natural oils and products. The surfactant and/or cosolvent may be, for example, a carboxylate ester, a plant-based ester, a terpene, a citrus-derived tepene, limonene, d-limonene or combinations thereof. In some embodiments, the surfactant and/or cosolvent may be for example, castor oil, cocoa oil, cocoa butter, coconut oil, soy oil, tallow oil, cotton seed oil, a naturally occurring plant oil, a plant extract, and combinations thereof.

In other embodiments, the surfactant and/or cosolvent may be a nonionic surfactant, ethoxylated soybean oil, ethoxylated castor oil, ethoxylated coconut fatty acid, amidified, ethoxylated coconut fatty acid, alkyl polyglucoside or alkyl polyglucoside-based surfactant, decylpolyglucoside, or alkyl decylpolyglucoside-based surfactant and combinations thereof.

In other embodiments, the surfactant and/or cosolvent may be ALFOTERRA 123-8S, ALFOTERRA 145-8S, ALFOTERRA L167-7S, ETHOX HCO-5, ETHOX HCO-25, ETHOX CO-40, ETHOX ML-5, ETHAL LA-4, AG-6202, AG-6206, ETHOX CO-36, ETHOX CO-81, ETHOX CO-25, ETHOX TO-16, ETHSORBOX L-20, ETHOX MO-14, S-MAZ 80K, T-MAZ 60 K 60, TERGITOL L-64, DOWFAX 8390, ALFOTERRA L167-4S, ALFOTERRA L123-4S, ALFOTERRA L145-4S, VeruSOL-1, VeruSOL-2, VeruSOL-3 surfactant, VeruSOL-4, VeruSOL-5, VeruSOL-6, Citrus Burst 1, Citrus Burst 2, Citrus Burst 3, and E-Z Mulse, Citrus Burst 1, Citrus Burst 2, Citrus Burst 3, E-Z Mulse, or combinations thereof. VeruSOL surfactants are available from VeruTEK, Inc. ALFOTERRA surfactants are available from Sasol North America. Citrus Burst surfactants are available from Florida Chemical. Ethox, Ethal, and Ethsorbox surfactants are available from Ethox Chemicals. S-Maz and T-Maz surfactants are available from BASF. Tergitol and DOWFAX are available from Dow Chemicals.

For example, blends of biodegradable citrus-based solvents (for example, d-limonene) and degradable surfactants derived from natural oils and products can be used. Other examples include compositions of surfactant and cosolvent containing at least one citrus terpene and at least one surfactant. A citrus terpene may be, for example, CAS No. 94266-47-4, citrus peels extract (citrus spp.), citrus extract, Curacao peel extract (Citrus aurantium L.), EINECS No. 304-454-3, FEMA No. 2318, or FEMA No. 2344. A surfactant may be a nonionic surfactant. For example, a surfactant may be an an ethoxylated soybean oil, an ethoxylated castor oil, an ethoxylated coconut fatty acid, or an amidified, ethoxylated coconut fatty acid, an alkyl polyglucoside or an alkyl polyglucoside-based surfactant, a decylpolyglucoside, or an alkyl decylpolyglucoside-based surfactant or combinations thereof. An ethoxylated castor oil can include, for example, a polyoxyethylene (20) castor oil, CAS No. 61791-12-6, PEG (polyethylene glycol)-10 castor oil, PEG-20 castor oil, PEG-3 castor oil, PEG-40 castor oil, PEG-50 castor oil, PEG-60 castor oil, POE (polyoxyethylene) (10) castor oil, POE (20) castor oil; POE (20) castor oil (ether, ester); POE (3) castor oil, POE (40) castor oil, POE (50) castor oil, POE (60) castor oil, or polyoxyethylene (20) castor oil (ether, ester). An ethoxylated coconut fatty acid can include, for example, CAS No. 39287-84-8, CAS No. 61791-29-5, CAS No. 68921-12-O, CAS No. 8051-46-5, CAS No. 8051-92-1, ethoxylated coconut fatty acid, polyethylene glycol ester of coconut fatty acid, ethoxylated coconut oil acid, polyethylene glycol monoester of coconut oil fatty acid, ethoxylated coco fatty acid, PEG-15 cocoate, PEG-5 cocoate, PEG-8 cocoate, polyethylene glycol (15) monococoate, polyethylene glycol (5) monococoate, polyethylene glycol 400 monococoate, polyethylene glycol monococonut ester, monococonate polyethylene glycol, monococonut oil fatty acid ester of polyethylene glycol, polyoxyethylene (15) monococoate, polyoxyethylene (5) monococoate, or polyoxyethylene (8) monococoate. An amidified, ethoxylated coconut fatty acid can include, for example, CAS No. 61791-08-0, ethoxylated reaction products of coco fatty acids with ethanolamine, PEG-11 cocamide, PEG-20 cocamide, PEG-3 cocamide, PEG-5 cocamide, PEG-6 cocamide, PEG-7 cocamide, polyethylene glycol (11) coconut amide, polyethylene glycol (3) coconut amide, polyethylene glycol (5) coconut amide, polyethylene glycol (7) coconut amide, polyethylene glycol 1000 coconut amide, polyethylene glycol 300 coconut amide, polyoxyethylene (11) coconut amide, polyoxyethylene (20) coconut amide, polyoxyethylene (3) coconut amide, polyoxyethylene (5) coconut amide, polyoxyethylene (6) coconut amide, polyoxyethylene (7) coconut amide, an alkyl polyglucoside or an alkyl polyglucoside-based surfactant, a decylpolyglucoside, or an alkyl decylpolyglucoside-based surfactant.

### Manganese-Based Octahedral Molecular Sieves (OMS)

In some embodiments, the manganese-based octahedral molecular sieves (OMS) are synthetic. In other words, they are not naturally occurring. Manganese-based octahedral molecular sieve(s) (OMS) constitute an example class of molecular sieves. These materials have one-dimensional tunnel structures and unlike zeolites, which have tetrahedrally coordinated species serving as the basic structural unit, these materials are based on six-coordinate manganese surrounded by an octahedral array of anions (e.g., oxide). The OMS framework architecture is dictated by the type of aggregation (e.g., corner-sharing, edge-sharing, or face-sharing) of the MnO₆ octahedra. The ability of manganese to adopt multiple oxidation states and of the MnO₆ octahedra to aggregate in different arrangements affords the formation of a large variety of OMS structures.

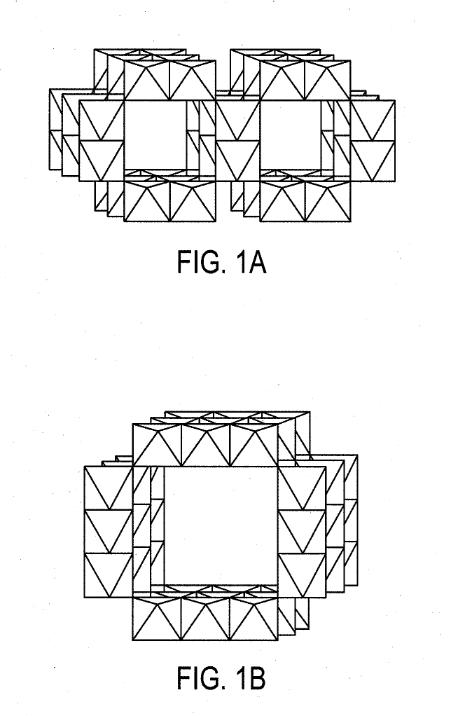

In one embodiment, the OMS catalyst comprises hollandites. Hollandites include a family of materials wherein the MnO₆ octahedra share edges to form double chains and the double chains share corners with adjacent double chains to form a 2×2 tunnel structure. The size of an average dimension of these tunnels is about 4.6 Å. A counter cation for maintaining overall charge neutrality such as H, Ba, K, Na, Pb, Rb, Cs, Li, Mg, Ca, Sr, Sn, Ge, Si, and the like, is present in the tunnels and is coordinated to the oxides of the double chains. The identity of the counter cation determines the mineral species or structure type. Hollandites are generally represented by the formula (M)Mn₈O₁₆, wherein M represents the counter cation and manganese is present in at least one oxidation state. Further, the formula may also include waters of hydration and is generally represented by (M)_{y}Mn₈O₁₆.xH₂O, where y is about 0.8 to about 1.5 and x is about 3 to about 10. Suitable hollandites include hollandite (BaMn₈O₁₆), cryptomelane (KMn₈O₁₆), manjiroite (NaMn₈O₁₆), coronadite (PbMn₈O₁₆), and the like, and variants of at least one of the foregoing hollandites. In one embodiment, the OMS catalyst comprises cryptomelane-type materials. In some embodiments some or all of the counter cation is K⁺. Herein below, we will refer to the (2×2) tunnel structure as OMS-2. The 2×2 tunnel structure of OMS-2 is diagrammatically depicted in FIG. 1A. Unless otherwise stated, it is to be understood that an example or embodiment described as using OMS-2 or another form of octahedral molecular sieves, such as OMS-1, also comprises other forms of octahedral molecular sieves that can have a range of counter cations.

An example material, K-OMS-2, may be prepared, for example, by combining an aqueous solution of KMnO₄ (0.2 to 0.6 molar), an aqueous solution of MnSO₄.H₂O (1.0 to 2.5 molar) and a concentrated acid such as HNO₃. The aqueous solution is refluxed at 100° C. for 18-36 hours. The product is filtered, washed and dried, typically at a temperature of 100 to 140° C. Similar procedures are known in the literature, for example, DeGuzman et al., Chem. Mater. 1994, 6, 815-821, which is incorporated by reference in its entirety. The counter cation may be changed by using other salts of permanganate in the process or may be prepared by ion exchange.

In other embodiments, KOMS-2 may be prepared by dissolving KMnO₄ in water and stirring to form a homogeneous solution. The concentration of KMnO₄ may be, for example, between about 0.195 and about 0.292 mol/L. The solution may then be subjected to hydrothermal treatment at a temperature between, for example, about 230° C. and about 250° C. In some embodiments, the solution is subjected to hydrothermal tratement of a temperature about 240° C. The hydrothermal treatment may proceed for about 3 to about 5 days. In some embodiments, the hydrothermal treatment proceeds for about 4 days. The resulting slurry may be washed with water to remove impurites and dried. was washed with DDW to remove any possible impurities.

In one embodiment, the OMS catalyst comprises todorokites. Todorokites include materials wherein the MnO₆ octahedra share edges to form triple chains and the triple chains share corners with adjacent triple chains to form a 3×3 tunnel structure. The size of an average dimension of these tunnels is about 6.9 Å. A counter cation, for maintaining overall charge neutrality, such as K, Na, Ca, Mg, and the like is present in the tunnels and is coordinated to the oxides of the triple chains. Todorokites are generally represented by the formula (M)Mn₃O₇, wherein M represents the counter cation and manganese is present in at least one oxidation state. Further, the formula may also include waters of hydration and is generally represented by (M)_{y}Mn₃O₇.xH₂O, where y is about 0.3 to about 0.5 and x is about 3 to about 4.5. Herein below, we will refer to the (3×3) tunnel structure as OMS-1. The 3×3 tunnel structure of OMS-1 is diagrammatically depicted in FIG. 1B, and may be prepared according to the methods described by O'Young et al. in U.S. Pat. No. 5,340,562, which is incorporated by reference in its entirety. The OMS-1 structure may be prepared, for example by (a) preparing a basic mixture of a manganous (Mn⁺²) salt, a permanganate salt and a soluble base material and having a pH of at least about 13; (b) aging said mixture at room temperature for at least 8 hours; (c) filtering and washing said aged material to render said material essentially chlorine-free; (d) ion exchanging said filtered material with a magnesium salt at room temperature for about 10 hours; and (e) filtering, washing and autoclaving said exchanged material to form the product. The manganous salt may be selected from the group consisting of MnCl₂, Mn(NO₃)₂, MnSO₄ and Mn(CH₃COO)₂. The permanganate salt may be, for example, Na(MnO₄), KMnO₄, CsMnO₄, Mg(MnO₄)₂, Ca(MnO₄)₂ and Ba(MnO₄)₂. The base material may be selected from the group consisting of KOH, NaOH and tetraalkyl ammonium hydroxides. As for the magnesium salt used to ion exchange the filtered material, this salt may be selected from the group consisting of MgCl₂, Mg(CH₃COO)₂ and MgSO₄. The preferred magnesium salt being MgCl₂. The ion exchanged material is autoclaved at a temperature ranging from about 100° C. to about 200° C. for at least about 10 hours or preferably at about 130° C. to about 170° C. for about 2 to 5 days.

The OMS may have other tunnel structures, for example 3×2, 3×4, 3×5 or 4×4 tunnel structures. Other tunnel structures are described, for example, in U.S. Pat. No. 5,578,282, which is incorporated by reference in its entirety.

In one embodiment, the OMS has an average Mn oxidation state of about 3 to about 4. Within this range the average oxidation state may be greater than or equal to about 3.2, or, more specifically, greater than or equal to 3.2, or even more specifically, greater than or equal to about 3.3. Average oxidation state may be determined by potentiometric titration.

The OMS may be used in any form that is convenient, such as particulate, aggregate, film or combination thereof. In addition, the OMS may be affixed to a substrate.

The OMS may further comprise an additional transition metal within the molecular framework as long as the incorporation of the additional transition metal does not collapse the one dimensional tunnel structure. According to the present invention, a portion of the framework manganese of the manganese oxide octahedral molecular sieves is replaced with one or more framework-substituting metal cations M⁺ⁿ (where n indicates an oxidation state which is stable in solution), e.g., a transition metal, preferably from Groups IB, IIB and VIII of the Periodic Table of the elements, lanthanum, iridium, rhodium, palladium and platinum. Examples of useful framework-substituting metals include Mg, Fe, Co, Ni, Cu, Ti, V, Cd, Mo, W, Cr, Zn, Sc, Mo, Zr, Ta, Hf, and lanthanide series metals. The larger counter cations such as potassium and barium can themselves serve as templates for crystallization and remain in the tunnel structures of some manganese oxide hydrates, particularly those of the [M]-OMS-2 structure where they may also be referred to as tunnel cations. Therefore, the counter cation can be selected to facilitate the selection, formation and stabilization of a desired product, such as the aforementioned [M]-OMS-2 structure, or to have a lesser effect (as with the smaller cations such as sodium and magnesium) so as to allow other preferred structures to form and/or to permit template materials other than the counter ion to act on the reaction solution.

Framework substituted OMS may be prepared according to the methods described in U.S. Pat. No. 5,702,674, incorporated herein by reference. Accordingly a general synthesis of an [M]-OMS-1 material comprises the following steps: a) reacting a source of manganese cation, a source of framework-substituting metal cation and a source of permanganate anion under basic conditions to provide an [M]-OL in which [M] designates the framework-substituting metal and OL designates the manganese oxide octahedral layered material; b) exchanging the [M]-OL with a source of counter cation; and, c) heating the exchanged [M]-OL to provide the [M]-OMS-1 material.

The manganese cation can be supplied by manganous salts such as MnCl₂, Mn(NO₃)₂, MnSO₄, Mn(CH₃COO)₂, etc. The permanganate anion can be supplied by permanganate salts such as Na(MnO₄), KMnO₄, Mg(MnO₄)₂, Ca(MnO₄)₂, Ba(MnO₄)₂, NH₄ (MnO₄), etc. Bases which can be used to provide an alkaline reaction medium include NaOH, KOH, tetraalkyl ammonium hydroxides, and the like. The basic reaction mixture is preferably aged, e.g., for at least 1 day and more preferably for at least about 7 days prior to the exchanging step. The source of counter cation used to ion exchange the [M]-OL can be a magnesium salt, e.g., MgCl₂ or Mg(CH₃COO)₂, or MgSO₄. The conditions of heating, e.g., autoclaving, of the exchanged [M]-OL can include a temperature of from about 100° C. to about 200° C. for at least about 10 hours and preferably from about 130° C. to about 170° C. for from about 2 to about 5 days.

A general synthesis of an [M]-OMS-2 material comprises heating a reaction mixture which includes a source of manganese cation, a source of framework-substituting metal cation, a source of counter cation and a source of permanganate anion under acidic conditions to provide the [M]-OMS-2. Suitable acids for adjusting the pH of the reaction mixture include the mineral acids, e.g., HCl, H₂SO₄, HNO₃ and strong organic acids such as toluene sulfonic acid and trifluoroacetic acid.

The framework-substituting metal cation should be present in the reaction mixture in a concentration effective to introduce the desired proportions of the metal(s) into the framework of the product's structure during the course of the reaction. Therefore, any suitable salt (inorganic or organic) of the selected metal(s) can be used which is sufficiently soluble provided, of course, that the anion does not interfere with the other reactants or the course of the reaction. For example, the oxides, nitrates, sulfates, perchlorates, alkoxides, acetates, and the like, can be used with generally good results. Specific examples include nitrates of cobalt, nickel, copper, zinc, lanthanum or palladium, sulfates of chromium, iron, cobalt, nickel or copper, and chlorides of magnesium, cobolt, nickel, copper, zinc or cadmium. Oxides of iron and titanium may also be used. Salts of noble metals, such as titanium, copper, nickel, gold, silver, palladium, or platinum, or combinations thereof may also be used.

Surfactant and/or Cosolvent

Some embodiments of the invention include a surfactant and/or cosolvent. In some embodiments, the surfactants and/or cosolvents are chosen to selectively adsorb onto outer and/or inner surfaces of the OMS particles. In some embodiments, the surfactants and/or cosolvents are chosen to selectively solubilize contaminants, for example, some non-aqueous phase liquids (NAPLs), that pose a risk to public health and/or the environment, without solubilizing other compounds.

Embodiments of the invention include compositions having manganese-based octahedral molecular sieves and a surfactant and/or cosolvent, wherein the manganese-based octahedral molecular sieves are coated with the surfactant or surfactant-cosolvent mixtures. The surfactant and/or cosolvents are chosen to selectively adsorb onto outer and/or inner surfaces of the OMS particles.

Surface coating of OMS particles provides unexpected benefits not realized with OMS alone. A surfactant-cosolvent coating enables the benefits of micellularization of NAPLs (creation of NAPL-surfactant micelles) in an oil-in-water colloidal suspension with the presence of OMS in the micelle matrix. This enables microemulsion catalysis whereby the NAPL is micellularized and the oxidative destruction by OMS reactions are facilitated in the same OMS-surfactant particle suspension matrix.

An additional benefit of providing an adsorbed coating on OMS particles is that it reduces soil mineral/OMS sorption reactions, increasing transport of OMS in soils more than possible with OMS alone. A benefit of adding a coated OMS catalyst, either coated OMS or coated OMS impregnated with additional inorganic compounds, to an oxidant being injected into the subsurface for remediation is that catalyst and NAPL micellaralizing agents can be added in a unitary mixture and that the catalyst has a protective coating that reduces catalyst interactions with the surrounding mineral matrix of the subsurface soil.

The term “solubilize” as used herein can refer to, for example, one or more of incorporating a contaminant in the aqueous phase, forming a molecular scale mixture of contaminant and water, incorporating contaminant at a micellar interface, and incorporating contaminant in a hydrophobic core of a micelle. The term “solution” as used herein can refer to, for example, a contaminant in the aqueous phase, a molecular scale mixture of contaminant and water, a contaminant at a micellar interface, and a contaminant in a hydrophobic core of a micelle.

The surfactant or surfactant-cosolvent mixture can be introduced sequentially or simultaneously (together) into a subsurface. For example, the surfactant or surfactant-cosolvent mixture can be introduced first, then the OMS and/or oxidant can be introduced. Alternatively, the OMS and/or oxidant can first be introduced, then the surfactant or surfactant-cosolvent mixture can be introduced. Alternatively, the OMS and/or oxidant and the surfactant or surfactant-cosolvent mixture can be introduced simultaneously. Simultaneously can mean that the oxidant and the surfactant and/or cosolvent are introduced within 6 months of each other, within 2 months of each other, within 1 month of each other, within 1 week of each other, within 1 day of each other, within one hour of each other, or together, for example, as a mixture of oxidant with surfactant and/or cosolvent. In each case, the OMS and/or oxidant is present in sufficient amounts at the right time, together with the surfactant, to oxidize contaminants as they are solubilized or mobilized by surfactant or cosolvent-surfactant mixture.

The introduced compositions, such as OMS and/or oxidant, surfactant, activator, cosolvent, and salts can be introduced into the subsurface in the solid phase. For example, the location where the compositions are introduced can be selected so that groundwater can dissolve the introduced compositions and convey them to where the contaminant is. Alternatively, the introduced compositions such as OMS and/or oxidant, surfactant, cosolvent, optional activators, and salts can be introduced into the subsurface as an aqueous solution or aqueous solutions. Alternatively, some compositions can be introduced in the solid phase and some can be introduced in aqueous solution.

In some embodiments, it may be desirable to include an activator in the method. An activator can be, for example, a chemical molecule or compound, or another external agent or condition, such as heat, temperature, or pH, that increases the rate of or hastens a chemical reaction. The activator may or may not be transformed during the chemical reaction that it hastens. Examples of activators which are chemical compounds include a metal, a transition metal, a chelated metal, a complexed metal, a metallorganic complex, metal nanoparticles and hydrogen peroxide. Examples of activators which are other external agents or conditions include heat, temperature, and high pH. Example activators include Fe(II), Fe(III), Fe(II)-EDTA, Fe(III)-EDTA, Fe(II)-citric acid, Fe(III)-citric acid, such as nanosized zero valent iron (nZVI), hydrogen peroxide, high pH, and heat. Activators may be added with OMS in the same remediation site, or in overlapping zones. Such activators may be promoters or inhibitors. The activators may cause reversible or irreversible changes.

In some embodiments it may be desirable to dope OMS with a transition or noble metal or mixtures of transition or noble metals or complexes of transition or noble metals into or onto the OMS to increase the catalytic activity of the OMS. As used herein, a “doped” OMS has one or more additional transition or noble metals or metal cations within the molecular framework, as discussed previously. Examples of suitable transition or noble metals include, for example, transition metals, preferably from Groups IB, IIB and VIII of the Periodic Table of the elements, lanthanum, iridium, rhodium, gold, silver, palladium and platinum. Other examples of useful framework-substituting metals include Mg, Fe, Co, Ni, Cu, Ti, V, Cd, Mo, W, Cr, Zn, Sc, Mo, Zr, Ta, Hf, and lanthanide series metals. Oxides of the above metals, include iron oxides or titanium oxides may also be incorporated.

### Screening

The method may involve separate screening and testing of the surfactant and cosolvents, separate testing of OMS and/or OMS/oxidant combinations (to meet site needs) and then testing the technologies together. This work can be done in the laboratory environment or in a combination of the laboratory environment and during field testing. This screening can be used to optimize the mutually compatible combination of OMS, contaminant, and medium to effectively destroy the contaminant.

When a contaminant is identified for remediation, different OMS/oxidant combinations can be screened to optimize effectiveness for contaminant remediation. In some instances, a surfactant and/or cosolvent or mixture thereof may assist in the solubilization or desorption of contaminants. In some instances, a surfactant and/or cosolvent or mixture thereof may be used to coat the surface of the OMS to increase the ability of OMS to be transported through surface water, groundwater and soil. In some instances, a surfactant and/or cosolvent or mixture thereof may be used to coat the surface of the OMS to increase the ability of OMS to form a unitary mixture with an organic contaminant providing both emulsification and oxidation, also known as microemulsion catalysis. The optimal combination of OMS/oxidant and optional surfactant and/or cosolvent may be determined under laboratory conditions or in a laboratory using samples collected from a site. The most effective combination may be, for example, the composition which most rapidly oxidizes the contaminant to be treated, or the composition which utilizes the materials most efficiently, i.e. without excess, or the combination with some other desired property, such as long-term activity, or mobilizing characteristics.

Testing of OMS and/or oxidants, surfactants, cosolvents and/or solvents can be conducted with the contaminant in the non-aqueous phase and/or sorbed phase in aqueous solution, or with the contaminant in a soil slurry or soil column. A soil slurry or soil column can use a standard soil or actual soil from a contaminated site. An actual soil can be homogenized for use in a soil slurry or soil column. Alternatively, an intact soil core obtained from a contaminated site can be used in closely simulating the effect of introduction of oxidant, surfactant, and/or solvent for treatment.

Testing of OMS and/or oxidants, surfactants, cosolvents, and/or solvents can be conducted with the contaminant in a batch experiment, with or without soil.

Aqueous phase screening can be used for the selection of appropriate OMS and/or oxidants with OMS for the destruction of selected COCs in collected groundwater from the site.

A control system can be run to compare the treatment conditions to those with no treatment. Additionally, tests of the stability of the surfactant or surfactant-cosolvent mixture can be performed to ensure that the OMS and/or oxidant does not immediately, or too quickly, oxidize the surfactant or cosolvent-surfactant mixture, impeding its dissolution properties.

For soil tests, site soils and groundwater representative of the highly contaminated soils targeted for treatment are collected. In some cases it may be desirable to add contaminant from the site to the test soils. (One objective of this step is to provide information concerning potential remedies for a range of soil contaminant conditions, including conditions approaching the most contaminated on the site.)

Soil slurry tests can be run on selected combinations of surfactant or surfactant-cosolvent mixtures to determine the solubilization of specific COCs relative to site cleanup criteria. Additionally, soil slurry tests can be run to screen and determine optimal dosing of OMS and/or oxidant for both dosing requirements and COCs treated. The technology of combining enhanced solubilization by surfactants or surfactant-cosolvent mixtures with chemical oxidation is a more aggressive approach to desorb residual tars, oils, and other NAPLs from the soils and simultaneously oxidize the desorbed COCs with the chosen chemical oxidant or OMS. A soil slurry control system can be run to compare the treatment conditions with no treatment.

Soil column tests can be run to closely simulate treatment performance and COC destruction using soil cores obtained from the most highly contaminated soils associated with the proposed treatment areas of a site. Results from soil column tests can be used to identify the treatment conditions and concentrations of chemicals to be evaluated. The soil column tests can consist of using OMS alone or a mixture of OMS and oxidants simultaneously with a surfactant or a mixture of surfactants or a cosolvent-surfactant mixture; various configurations or concentrations of oxidants or mixtures of OMS and/or oxidants used alone or simultaneously with a surfactant or a cosolvent-surfactant mixture can be selected for study based on soil slurry tests. By monitoring surfactant concentrations and/or interfacial tension in the effluent of the soil columns, the reactivity of the surfactant and cosolvents with the OMS and/or oxidants can be determined to determine compatibility of OMS and/or oxidants with surfactants and cosolvents. Monitoring of COC concentrations in the effluent of the column can also determine the ability of the oxidant to destroy the cosolvent-surfactant or surfactant micelles or emulsions and react with the COCs.

Surfactant or surfactant-cosolvent mixtures to solubilize and desorb contaminants of concern (COCs) from site soils or from water mixtures can be screened for use in a combined surfactant-OMS/oxidant treatment. It is preferred to use blends of biodegradable citrus-based solvents (for example, d-limonene) and degradable surfactants derived from natural oils and products.

The use of OMS to reduce contaminants is compatible with surfactant enchanced in situ chemical oxidation (S-ISCO®) remediation technology, as described in US Pre-Grant Publication 2008/0207981, which is incorporated by reference in its entirety.

### S-ISCO Remediation

Surfactant enhanced in situ chemical oxidation (S-ISCO® remediation, VeruTEK, Inc.) remediation depends on choosing the correct surfactants or surfactant-cosolvent mixtures that create the most effective solubilized micelle or microemulsion with the NAPL present in the soil, such that a Winsor Type I phenomenon occurs and other Winsor type behaviors are generally avoided. Once an adequate Winsor Type I solubilized micelle or microemulsion has formed and thus increases the apparent solubility of the NAPL, the solubilized micelle or microemulsed NAPL is able to enter into “aqueous phase reactions” and in the case of S-ISCO® remediation, it can be oxidized using a chemical oxidant such as permanganate, ozone, persulfate, activated persulfate, percarbonate, activated percarbonate, or hydrogen peroxide, or ultraviolet (uV) light or any combination of these oxidants with or without uV light. It is well known in the literature that several methods can be used to activate or catalyze peroxide and persulfate to form free radicals such as free or chelated transition metals and uV light. Persulfate can be additionally activated at both high and low pH, by heat or by peroxides, including calcium peroxides. Persulfate and ozone can be used in a dual oxidant mode with hydrogen peroxide.

In an embodiment of the invention, increased solubilization of NAPL or sorbed contaminants can be attained in Winsor Type I systems, without the need for complete extraction well recovery of injected and treated liquids. In situ chemical oxidation of the solubilized or microemulsed NAPLs in a Winsor Type I system eliminates the necessity of complete liquid pumping extraction recovery of the solubilized NAPL. Elimination of extraction systems can avoid technical challenges associated with costly complete plume capture, costly above ground treatment systems, requirements to recycle surfactant or surfactant-cosolvent mixtures, and to dispose or reinject the bulk liquid back into the subsurface. Winsor Type I microemulsions can be used to solubilize NAPLs without NAPL mobilization (see, Martel, et al., Ground Water, vol. 31, pp. 789-800, 1993; and Martel, et al., Ground Water, vol. 34, pp. 143-154, 1996. These systems have the advantage of high solubilization of NAPLs (although not as high as middlephase microemulsions) with relatively low amounts of chemical additives required. In microemulsions, solubilization of the oil phase into the microemulsion can be related to interfacial tension by an inverse squared relationship (see Chun, et al., J. Colloid Interface Sci., vol. 35, pp. 85-101, 1971). Remediation systems that rely on Winsor Type I solubilized micelle or microemulsification can be less efficient than those that rely on Winsor Type III microemulsions and mobilization, since solubilization is lower at the higher interfacial tensions required to prevent mobilization. However, desorption and solubilization of contaminants using Winsor Type I microemulsions are controllable such that the risk of off-site mobilization of NAPL contaminants of concern (COCs) is minimal and that complete recovery of injected chemicals, mobilized NAPL phases, and solubilized NAPL or sorbed chemicals using extraction wells is not required. These characteristics of S-ISCO® (surfactant enhanced in situ chemical oxidation) remediation can be useful in remedying manufactured gas plant (MGP) sites as well as sites with chlorinated solvents, petroleum hydrocarbons, pesticides, herbicides, polychlorinated biphenyls, and other NAPL or sorbed COCs. Under solubilizing conditions, the NAPL removal rate is dependent on the increase in solubility of the NAPL in the surfactant mixture. Under desorbing conditions, the sorbed COC species removal rate is dependent on the rate of desorption of the COC into the surfactant or surfactant-cosolvent mixture.

The invention involves a method and process of increasing the solubility of contaminants, such as normally low solubility nonaqueous phase liquids (NAPLs), sorbed contaminants, or other chemicals in soils in surface and ground water, and simultaneously or subsequently oxidizing the chemicals using a chemical oxidant without the need of extraction wells for the purpose of recovering the injected cosolvents and/or surfactants with NAPL compounds. Examples of contaminants are dense nonaqueous phase liquids (DNAPLs), light nonaqueous phase liquids (LNAPLs), polycyclic aromatic hydrocarbons (PAHs), chlorinated solvents, pesticides, polychlorinated biphenyls and various organic chemicals, such as petroleum products. Contaminants can be associated with, for example, manufactured gas plant residuals, creosote wood treating liquids, petroleum residuals, pesticide, or polychlorinated biphenyl (PCB) residuals and other waste products or byproducts of industrial processes and commercial activities. Contaminants may be in the liquid phase, for example, NAPLs, sorbed to the soil matrix or in the solid phase, for example, certain pesticides.

The screening of several surfactants, cosolvents, or surfactant-cosolvent mixtures for dissolution and/or desorption of a given NAPL or sorbed organic chemical (or mixture of chemicals) can lead to a customized and optimal surfactant, cosolvent, or surfactant-cosolvent mixture to dissolve either some or all of the NAPLs or sorbed chemicals. In order to dissolve some or all of the NAPLs or sorbed chemicals, a surfactant or mixture of surfactants alone, a cosolvent or mixture of cosolvents alone, or a mixture of surfactants and cosolvents can be used. For example, certain volatile constituents in the NAPLs may pose a health or ecological risk at a particular site, that is, be contaminants of concern (COCs), but the NAPLs may contain many other compounds that do not result in risks.

The term “solubilize” as used herein can refer to, for example, one or more of incorporating a contaminant in the aqueous phase, forming a molecular scale mixture of contaminant and water, incorporating contaminant at a micellar interface, and incorporating contaminant in a hydrophobic core of a micelle. The term “solution” as used herein can refer to, for example, a contaminant in the aqueous phase, a molecular scale mixture of contaminant and water, a contaminant at a micellar interface, and a contaminant in a hydrophobic core of a micelle. Solubilizing contaminant can contribute to forming a compatible combination of OMS, contaminant and optional oxidant and/or surfactant.

The OMS, oxidant, and surfactant or surfactant-cosolvent mixture can be selected so that the OMS and/or oxidant do not substantially react with the surfactant or cosolvent. Alternatively, the surfactant or surfactant-cosolvent mixture can be selected so that the surfactant can function to solubilize contaminant, even if the OMS and/or oxidant reacts with the surfactant or cosolvent. Alternatively, the surfactant or surfactant-cosolvent mixture can be selected so that the OMS and/or oxidant reacts with the surfactant so as to promote the destruction of the contaminant. For example, the OMS and/or oxidant may react with the surfactant to alter the chemistry of the surfactant, so that the altered surfactant selectively solubilizes certain contaminants. In each of these examples, the OMS, contaminant, and medium may be in a mutually compatible combination effective to oxidize the contaminant.

In an embodiment, an amount of surfactant or surfactant-cosolvent mixture is introduced into a subsurface, for example, rock, soil, or groundwater, including a contaminant, to form a Winsor Type I system. In order to form a Winsor Type I system, the amount of surfactant or surfactant-cosolvent mixture added is controlled and restricted. In other words, insufficient surfactant or surfactant-cosolvent mixture is added to induce the formation of a Winsor Type II system, but enough to result in increased solubilization of contaminant above the aqueous critical micelle concentration. Thus, the formation of a Winsor Type II system and the mobilization of contaminant, associated with a Winsor Type II system, is avoided or minimized. By avoiding or minimizing the mobilization of contaminant, the problem of contaminant migrating to areas not being treated can be avoided.

The mobilization of contaminant can be avoided by controlling the rate of oxidation in the subsurface. For example, by ensuring that the overall rate of oxidation of contaminant is greater than the overall rate of solubilization of contaminant, mobilization can be avoided. The overall rate of oxidation can be controlled by controlling the concentration of OMS and/or oxidant in the subsurface. For example, if a greater mass of OMS and/or oxidant is introduced into a given volume of subsurface, then the concentration of OMS and/or oxidant in that volume will be greater and the rate of oxidation will be faster. On the other hand, if a lesser mass of OMS and/or oxidant is introduced into a given volume of subsurface, then the concentration of oxidant in that volume will be lesser and the rate of oxidation will be slower. The overall oxidation rate can be controlled by selection of the specific oxidant used, as well as the concentration of the oxidant.

In another embodiment of the invention, the contaminant may be locally mobilized in a controlled manner; then, the contaminant which has been mobilized may be oxidized. A Winsor Type II system can be locally formed, for example, near a NAPL accumulation zone in the subsurface, and then the emulsion can be broken with an oxidant or other emulsion breaker to make the NAPL more available to react with the oxidant solution. For example, at many LNAPL and DNAPL sites NAPLs may accumulate in sufficient thicknesses that the relative permeability to water in the NAPL accumulation zone is very low and injected chemicals simply pass over, under or around the NAPL accumulation zone, leaving the area untreated. While a Winsor Type I system can increase the rate of solubilization of contaminants of concern (COCs) from the NAPL phase to the aqueous phase, this still may not be an optimal treatment of the site. By creating a localized Winsor Type II or III system, NAPLs may be mobilized more efficiently into subsurface zones where they are more available to and have greater contact with chemicals injected into the aqueous phase. In some cases, it is preferable to employ a sequential treatment of NAPL using first a Winsor Type II or III system to temporarily mobilize NAPL then to break the Winsor Type II or III system with a breaker or oxidant, to create, for example, a Winsor Type I system enabling an increased rate of solubilization than achievable with a Winsor Type I system alone.

Minimal mobilization can be defined as follows. NAPL may move through colloidal transport but bulk (macroscopic) movement of NAPL downward or horizontal is not occurring.

In an alternative embodiment, an amount of surfactant or surfactant-cosolvent mixture is introduced into a subsurface, for example, soil or groundwater, including a contaminant, to form a Winsor Type III system, that is, a middle phase microemulsion. Such a Winsor Type III system can mobilize a contaminant phase in the microemulsion. For example, when the NAPL content of soil in a subsurface is low, a Winsor Type III middle phase microemulsion can be formed to mobilize the NAPL into a bulk pore space and then oxidize the emulsified NAPL in the bulk pore space, for example, by chemical oxidation.

The surfactant or surfactant-cosolvent mixture can be introduced sequentially or simultaneously (together) into a subsurface. For example, the surfactant or surfactant-cosolvent mixture can first be introduced, then the OMS and/or oxidant can be introduced. Alternatively, the OMS and/or oxidant can first be introduced, then the surfactant or surfactant-cosolvent mixture can be introduced. Alternatively, the OMS and/or oxidant and the surfactant or surfactant-cosolvent mixture can be introduced simultaneously. Simultaneously can mean that the oxidant and the surfactant and/or cosolvent are introduced within 6 months of each other, within 2 months of each other, within 1 month of each other, within 1 week of each other, within 1 day of each other, within one hour of each other, or together, for example, as a mixture of oxidant with surfactant and/or cosolvent. In each case, the OMS and/or oxidant is present in sufficient amounts at the right time, together with the surfactant, to oxidize contaminants as they are solubilized or mobilized by surfactant or cosolvent-surfactant mixture.

The introduced compositions, such as OMS and/or oxidant, surfactant, cosolvent, and salts can be introduced into the subsurface in the solid phase with or without a solid phase diluent. For example, the location where the compositions are introduced can be selected so that groundwater can dissolve or suspend the introduced compositions and convey them to where the contaminant is. Alternatively, the introduced compositions such as OMS and/or oxidant, surfactant, cosolvent, optional activators, and salts can be introduced into the subsurface as an aqueous solution or suspensions. Alternatively, some compositions can be introduced in the solid phase and some can be introduced in aqueous solution.

An embodiment of the invention involves the use of controlling the specific gravity of the introduced compositions, consisting of OMS and/or oxidants, salts, surfactants, and/or surfactant-cosolvent mixtures. By controlling the specific gravity of the injected solutions, greater control of the vertical interval of the volume of soil treated can be achieved. Sites with high concentrations of NAPL or sorbed organic chemicals in soils generally require higher concentrations of oxidants than needed at sites with lower concentration of contaminants. Injecting OMS/oxidant//surfactant chemicals into the subsurface at sites with a high demand for these injected chemicals can result in solutions with densities great enough to induce downward density driven flow caused by gravitational effects. Variation of the concentration of salts associated with either the oxidant or externally added salts affects the density, which affects the vertical interval of soil contacted by the injected liquids. Controlling the density of the injected liquids enables a controlled and deliberate treatment of contaminated intervals in the subsurface.

The injection flow rate is another parameter which can be controlled to deliver treatment chemicals, e.g., OMS, oxidant, and surfactant, to where chemicals of concern (COCs) reside.

For example, if dense non-aqueous phase liquids (DNAPLs) are to be targeted, the density of the injected liquids can be selected to be from about as great to greater than the density of water. For example, the density of the injected liquids can be selected to be in the range of from about 1.0 gram/cm³ to about 1.5 gram/cm³.

Field applications of S-ISCO® technologies at sites with organic contaminants in either or both of the LNAPL and DNAPL phases or with sorbed phases are dependent on several factors for successful achievement of removal of the NAPL or sorbed phases. These factors can include the following.

1) Effective delivery of injected OMS, oxidants, and surfactants or surfactant-cosolvent mixture into the subsurface.
2) Travel of OMS, oxidant, and surfactant solutions to the desired treatment interval in the soil.
3) Selection of surfactants or cosolvent-surfactant mixtures and oxidants to ensure coelution of the surfactants or cosolvent-surfactant mixtures, OMS and/or oxidants enabling travel of the injected species to the desired treatment interval in the soil.
4) Desorption and apparent solubilization of residual NAPL phases into the aqueous phase for destruction by the oxidant and radical species.
5) Reactions of oxidant and radical species with target mobilized contaminants of concern (COCs).
6) Production of by-products from oxidation and any other injected solutions, including organic or metal species that are below concentrations of regulatory thresholds.
7) Oxidation or natural or enhanced biodegradation of the surfactant or surfactant-cosolvent mixture.
8) Adequate monitoring of COCs, injected OMS and/or oxidant solutions, essential geochemical parameters and any other environmental media potentially affected by the treatment.

The method of using S-ISCO® technology may involve separate screening and testing of the surfactant and cosolvents, separate testing of optimal OMS and/or oxidant (to meet site needs) and then testing the technologies together. This work can be done in the laboratory environment or in a combination of the laboratory environment and during field testing. This method can involve following steps.

Collection of site soils and groundwater representative of the highly contaminated soils targeted for treatment. In some cases it may be desirable to add NAPL from the site to the test soils. (One objective of this step is to provide information concerning potential remedies for a range of soil contaminant conditions, including conditions approaching the most contaminated on the site.)

Surfactant or surfactant-cosolvent mixtures to solubilize NAPL components and desorb contaminants of concern (COCs) from site soils or from NAPL in water mixtures can be screened for use in a combined surfactant-oxidant treatment. It is preferred to use blends of biodegradable citrus-based solvents (for example, d-limonene) and degradable surfactants derived from natural oils and products.

For example, a composition of surfactant and cosolvent can include at least one citrus terpene and at least one surfactant. A citrus terpene may be, for example, CAS No. 94266-47-4, citrus peels extract (citrus spp.), citrus extract, Curacao peel extract (Citrus aurantium L.), EINECS No. 304-454-3, FEMA No. 2318, or FEMA No. 2344. A surfactant may be a nonionic surfactant. For example, a surfactant may be an ethoxylated castor oil, an ethoxylated coconut fatty acid, or an amidified, ethoxylated coconut fatty acid. An ethoxylated castor oil can include, for example, a polyoxyethylene (20) castor oil, CAS No. 61791-12-6, PEG (polyethylene glycol)-10 castor oil, PEG-20 castor oil, PEG-3 castor oil, PEG-40 castor oil, PEG-50 castor oil, PEG-60 castor oil, POE (polyoxyethylene) (10) castor oil, POE (20) castor oil; POE (20) castor oil (ether, ester); POE (3) castor oil, POE (40) castor oil, POE (50) castor oil, POE (60) castor oil, or polyoxyethylene (20) castor oil (ether, ester). An ethoxylated coconut fatty acid can include, for example, CAS No. 39287-84-8, CAS No. 61791-29-5, CAS No. 68921-12-0, CAS No. 8051-46-5, CAS No. 8051-92-1, ethoxylated coconut fatty acid, polyethylene glycol ester of coconut fatty acid, ethoxylated coconut oil acid, polyethylene glycol monoester of coconut oil fatty acid, ethoxylated coco fatty acid, PEG-15 cocoate, PEG-5 cocoate, PEG-8 cocoate, polyethylene glycol (15) monococoate, polyethylene glycol (5) monococoate, polyethylene glycol 400 monococoate, polyethylene glycol monococonut ester, monococonate polyethylene glycol, monococonut oil fatty acid ester of polyethylene glycol, polyoxyethylene (15) monococoate, polyoxyethylene (5) monococoate, or polyoxyethylene (8) monococoate. An amidified, ethoxylated coconut fatty acid can include, for example, CAS No. 61791-08-0, ethoxylated reaction products of coco fatty acids with ethanolamine, PEG-11 cocamide, PEG-20 cocamide, PEG-3 cocamide, PEG-5 cocamide, PEG-6 cocamide, PEG-7 cocamide, polyethylene glycol (11) coconut amide, polyethylene glycol (3) coconut amide, polyethylene glycol (5) coconut amide, polyethylene glycol (7) coconut amide, polyethylene glycol 1000 coconut amide, polyethylene glycol 300 coconut amide, polyoxyethylene (11) coconut amide, polyoxyethylene (20) coconut amide, polyoxyethylene (3) coconut amide, polyoxyethylene (5) coconut amide, polyoxyethylene (6) coconut amide, polyoxyethylene (7) coconut amide, an alkyl polyglucoside or an alkyl polyglucoside-based surfactant, a decyl polyglucoside or an alkyl decylpolyglucoside-based surfactant.

Aqueous phase screening can be used for the selection of appropriate oxidants with OMS for the destruction of selected COCs in collected groundwater from the site.

A control system can be run to compare effects of the treatment conditions to those with no treatment. Additionally, tests of the stability of the surfactant or surfactant-cosolvent mixture can be necessary to ensure that the OMS and/or oxidant does not immediately, or too quickly, oxidize the surfactant or cosolvent-surfactant mixture rendering it useless for subsequent dissolution.

Soil slurry tests can be run on selected combinations of surfactant or surfactant-cosolvent mixtures to determine the solubilization of specific COCs relative to site cleanup criteria. Additionally, soil slurry tests can be run to screen and determine optimal dosing of OMS and/or oxidant for both dosing requirements and COCs treated. The technology of combining enhanced solubilization by surfactants or surfactant-cosolvent mixtures with chemical oxidation is a more aggressive approach to desorb residual tars, oils, and other NAPLs from the soils and simultaneously oxidize the desorbed COCs with the chosen chemical oxidant. A soil slurry control system can be run to compare the treatment conditions with no treatment.

Soil column tests can be run to closely simulate treatment performance and COC destruction using soil cores obtained from the most highly contaminated soils associated with the proposed treatment areas of a site. Results from soil column tests can be used to identify the treatment conditions and concentrations of chemicals to be evaluated. The soil column tests can consist of using OMS alone or a mixture of OMS and oxidants simultaneously with a surfactant or a mixture of surfactants or a cosolvent-surfactant mixture; various configurations or concentrations of oxidants or mixtures of oxidants used alone or simultaneously with a surfactant or a cosolvent-surfactant mixture can be selected for study based on soil slurry tests. Different activation methods can additionally be tested using soil column testing. By monitoring surfactant concentrations and/or interfacial tension in the effluent of the soil columns, the reactivity of the surfactant and cosolvents with the OMS and/or oxidants can be determined to determine compatibility of OMS and/or oxidants with surfactants and cosolvents. Monitoring of COC concentrations in the effluent of the column can also determine the ability of the oxidant to destroy the cosolvent-surfactant or surfactant micelles or emulsions and react with the COCs.

Design parameters include moles of oxidant used in the tests per mole of COCs destroyed, moles of oxidant used per mass of soil treated, moles of surfactant utilized per mole of COC solubilized, moles of surfactant or of cosolvent-surfactant mixture destroyed per unit contact time in the batch or column test, rates of COC destruction, rates of oxidant utilization, and loading rates of chemicals. These parameters can be used to optimize the mutually compatible combination of OMS, contaminant, and medium to effectively destroy the contaminant.

An example cosolvent-surfactant mixture is a mixture of d-limonene and biodegradable surfactants, for example, VeruSOL-3 surfactant. Verusol-3 surfactant includes a surfactant blend of ethoxylated monoethanolamides of fatty acids of coconut oil and polyoxyethylene castor oil and d-limonene.

When the process according to the present invention is complete, the remaining concentration of contaminants is greatly reduced from the initial concentration. The remaining contaminants, whether they reside in the dissolved or in the sorbed phases are much more readily amenable to natural attenuation processes, including biodegradation.

Examples of cosolvents which preferentially partition into the NAPL phase include higher molecular weight miscible alcohols such as isopropyl and tert-butyl alcohol. Alcohols with a limited aqueous solubility such as butanol, pentanol, hexanol, and heptanol can be blended with the water miscible alcohols to improve the overall phase behavior. Given a sufficiently high initial cosolvent concentration in the aqueous phase (the flooding fluid), large amounts of cosolvent partition into the NAPL. As a result of this partitioning, the NAPL phase expands, and formerly discontinuous NAPL ganglia can become continuous, and hence mobile. This expanding NAPL phase behavior, along with large interfacial tension reductions, allows the NAPL phase to concentrate at the leading edge of the cosolvent slug, thereby increasing the mobility of the NAPL. Under certain conditions, a highly efficient piston-like displacement of the NAPL is possible. Because the cosolvent also has the effect of increasing the NAPL solubility in the aqueous phase, small fractions of the NAPL which are not mobilized by the above mechanism are dissolved by the cosolvent slug.

The phase behavior of the specific system is controllable. Laboratory experiments have shown that surfactant/cosolvents that preferentially stay with the aqueous phase can dramatically increase the solubility of NAPL components in the aqueous phase. In cases where the solvent preferentially partitions into the aqueous phase, separate phase NAPL mobilization is not observed and the NAPL removal occurs by enhanced dissolution. Solubilization has the added benefit of increasing bioavailability of the contaminants and increased rate of biological degradation of the contaminants.

### Surfactant Solubilization, Surfactant Mobilization, and Microemulsions

Surfactants are surface active agents. They are molecules that have both hydrophilic and lipophilic parts. The amphophilic nature of surfactant molecules (having both positive and negative charged parts) causes them when injected into aquifers to accumulate at the water-solid interface. Furthermore, surfactant molecules can coagulate into aggregates known as micelles. Micelles are colloidal-sized aggregates. The surfactant concentration at which micelle formation begins is known as the critical micelle concentration (CMC). Determining the CMC of a surfactant or a cosolvent-surfactant mixture mixtures is an important component in managing S-ISCO® remediation. Micelle formation generally distinguishes surfactants from amphophilic molecules (for example, alcohols) that do not form micelles and have lower surface activity.

Surfactant addition above the CMC results in the formation of additional micelles. Winsor Type behavior describes different types of micelle formation that is relevant to remediation of sites with NAPLs or sorbed COCs. Winsor Type I micelles have a hydrophilic exterior (the hydrophilic heads are oriented toward the exterior of the aggregate) and a hydrophobic interior (the hydrophobic tails are oriented toward the interior of the aggregate). This type of micelle can be likened to dispersed oil drops or molecules; the hydrophobic inside of the micelle acts as an oil sink into which hydrophobic contaminants can partition. The increased scale aqueous solubility of organic compounds at concentrations above the CMC is referred to as “solubilization.” During solubilization, surfactant concentration increases, additional micelles are formed and the contaminant solubility continues to increase. S-ISCO® remediation optimizes and controls solubilization reactions at NAPL and sorbed COC sites.

Winsor Type II surfactants are oil soluble and have a low hydrophile-lipophile balance (HLB). These type of surfactants partition into the oil phase, and may form reverse micelles. A reverse micelle has a hydrophilic interior and lipophilic exterior. The resulting phenomenon is similar to dispersed water drops in the oil phase. Surfactant systems intermediate between micelles and reverse micelles can result in a third phase (Winsor Type III system) known as a middle-phase microemulsion. The middle phase system is known to coincide with very low interfacial tensions (IFTs) and can be used for bulk (pump-and-treat) extraction of contaminants from residual saturation. Surfactant-enhanced remediation by this approach is often referred to as mobilization. The surfactants or cosolvent-surfactant mixtures used and the chemical conditions under which solubilization and mobilization occur are very different. Solubilization can be effected at very low surfactant concentrations that can be orders of magnitude below that at which mobilization occurs.

Microemulsions are a special class of a Winsor Type I system in which the droplet diameter of the dispersed phase is very small and uniform. Droplet diameters of oil-in-water microemulsions generally range between 0.01 and 0.10 μm. These microemulsions are single phase, optically transparent, low viscosity, thermodynamically stable systems that form spontaneously on contact with an oil or NAPL phase. A properly designed microemulsion system is dilutable with water and can be transported through porous media by miscible displacement. This is in contrast to surfactant-based technologies that utilize Winsor Type III middle-phase microemulsions which depend on mobilization to transport the NAPL phase as an immiscible displacement process.

Microemulsions are usually stabilized by a surfactant and a cosolvent. A mixture of water, surfactant, and cosolvent form the microemulsion “precursor”; this “precursor” should be a stable single-phase, low viscosity system. When this precursor is injected into a porous medium containing residual NAPL, the NAPL is microemulsified and can be transported to an extraction well as a single phase, low viscosity fluid. Suitable cosolvents are low-molecular-weight alcohols (propanol, butanol, pentanol, hexanol, etc.), organic acids, and amines. There are many surfactants that form oil-in-water microemulsions in the presence of alcohol cosolvents. Some of these surfactants have been given direct food additive status by the FDA, are non-toxic, and are readily biodegradable.

Any surfactant-based remediation technology must utilize surfactants with optimum efficiency (i.e., minimal losses to sorption, precipitation, coacervate formation, crystallization, or phase changes), environmental acceptance, and biodegradability. Surfactants can be lost from a solution by adsorption onto aquifer solid phases and by precipitation with polyvalent cations dissolved in ground water or adsorbed onto cation exchange sites. Surfactants without cosolvents sometimes create viscous macromolecules or liquid crystals when they combine with the contaminants, which can block fluid flow. Cosolvents can be used to stabilize the system and avoid macromolecule formation. It has been suggested that chromatographic separation of surfactants and cosolvents could reduce microemulsification efficiency. However, experimental observations on systems containing 10 to 15 percent residual NAPL saturation indicate that, if chromatographic separation occurred, its effect on microemulsification was negligible.

### Methods for Determining Contaminant Remediation Protocols

A method for determining a contaminant remediation protocol, for example, of a protocol for remediating soil in a subsurface contaminated with NAPL or other organic chemicals, can include the following steps. Site soil samples can be collected under zero headspace conditions (e.g., if volatile chemicals are present); for example, samples representative of the most highly contaminated soils can be collected. The samples can be homogenized for further analysis. A target contaminant or target contaminants in the soil can be identified. The demand of a sample of oxidant per unit soil mass can be determined; for example, the demand of a soil sample for a persulfate oxidant, such as sodium persulfate, can be determined. An oxidant is, for example, a chemical or agent that removes electrons from a compound or element, increases the valence state of an element, or takes away hydrogen by the addition of oxygen. A suitable oxidant and/or a suitable mixture of an oxidant and an activator for oxidizing the target contaminant can be selected. Suitable surfactants, mixtures of surfactants, and/or mixtures of surfactants, cosolvents, and/or solvents capable of solubilizing and/or desorbing the target contaminant or contaminants can be identified; for example, suitable biodegradable surfactants can be tested. Suitable solvents capable of solubilizing and/or desorbing the target contaminant or contaminants can be identified; for example, suitable biodegradable solvents such as d-limonene can be tested. Various concentrations of cosolvent-surfactant mixtures or surfactants alone can be added to water or groundwater from a site along with controlled quantities of NAPLs. Relationships of the extent of dissolution of the NAPL compounds with the varying concentrations of the cosolvent-surfactant mixtures or surfactants can be established by measuring the concentrations of the NAPL compounds that enter the aqueous phase. Relationships between the interfacial tension and solubilized NAPL compounds and their molecular properties, such as the octanol-water partition coefficient (K_{ow}) can also be established that enable optimal design of the dissolution portion of the S-ISCO® process. Various concentrations of cosolvent-surfactant mixtures or surfactants alone can be added to water or groundwater from a site along with controlled quantities of contaminated soils from the site. Relationships of the extent of solubilization of the sorbed COC compounds with the varying concentrations of the cosolvent-surfactant mixtures or surfactants can be established by measuring the concentrations of the sorbed COCs that enter the aqueous phase. Relationships between the interfacial tension and desorbed and solubilized compounds and their molecular properties, such as the octanol water partition coefficient (K_{ow}), can also be established that enable optimal design of the dissolution portion of the S-ISCO® process. The simultaneous use of oxidants and surfactants or cosolvent-surfactant mixtures in decontaminating soil can be tested. For example, the effect of the oxidant on the solubilization characteristics of the surfactant can be evaluated, to ensure that the oxidant and surfactant can function together to solubilize and oxidize the contaminant. The quantity of surfactant for injection into the subsurface can be chosen to form a Winsor I system or a microemulsion.

For example, the type and quantity of surfactants and optionally of cosolvent required to adsorb onto OMS and/or solubilize the target contaminant can be determined in a batch experiment.

For example, it is important that the OMS and/or oxidant not react with the surfactant so fast that the surfactant is consumed before the surfactant can solubilize the contaminant. On the other hand, the surfactant should not reside in the subsurface indefinitely, to avoid being a contaminant itself. This degradation can be caused by living organisms, such as bacterial, through a biodegradation process. On the other hand, the surfactant can be selected to slowly react with the OMS and/or oxidant, so that the oxidant survives sufficiently long to solubilize the contaminant for the purpose of enhancing its oxidation, but once the contaminant has been oxidized, the surfactant itself is oxidized by the remaining oxidant. Experimentation on the effects of various oxidants with OMS, and combinations of oxidants with OMS on the stability and activity of cosolvent-surfactant mixtures and surfactants can be readily conducted to provide information to optimize treatment conditions. Testing of the sorption or reaction of the surfactant or surfactant-cosolvent mixture can be conducted to determine the transport and fate properties of the surfactant or surfactant-cosolvent mixture in soils, rock and groundwater. Testing is conducted in batch aqueous or soil slurry tests in which individual cosolvent-surfactant mixtures or surfactants at specified initial concentrations are mixed together with individual oxidants or mixtures of oxidants and activators. The duration of the tests can be, for example from 10 days to 120 days, dependent on the stability of the oxidant-surfactant system needed for a particular application. Variation of the surface tension over time in several solutions is presented in an Example below.

### Selection of Surfactant System

Development of a surfactant system for use in S-ISCO® remediation can include preparing a series of surfactants or surfactant-cosolvent mixtures. One characteristic of some surfactant-cosolvent mixtures is the ratio of the number of ethylene oxide groups to propylene oxide groups (EO/PO ratio) in the backbones of the constituent molecules. The surfactant-cosolvent mixtures in the series can have a range of EO/PO ratios. The EO/PO ratio of a mixture can be determined from knowledge of the EO/PO ratios of the constituent molecules and the molar fraction of each type of constituent molecule in the mixture. The hydrophobicity of the surfactant-cosolvent mixture can be tailored by adjusting the EO/PO ratio through varying the types of surfactant and cosolvent molecules in the mixture, or by varying the concentrations of the types of surfactant and cosolvent molecules in the mixture.

The hydrophilic-lipophilic balance (HLB) is a characteristic of a surfactant. An HLB of less than 10 indicates a surfactant in which the oleophilic (hydrophobic) property is stronger than the hydrophilic property of the surfactant. An HLB of greater than 10 indicates a surfactant in which the hydrophilic property is stronger than the oleophilic (hydrophobic) property of the surfactant.

A characteristic of organic chemicals is a characteristic known as the octanol-water partition coefficient (Kow). The Kow can be determined, for example, in a batch test in which the concentrations of an organic molecular species (such as COCs) in the octanol phase and the concentration of the molecular species in the water phase are measured. The partitioning of the organic species between the octanol and water phases is a property of organic chemicals reported in the literature from both experimental measurements and theoretical approximations. Relationships between the octanol-water partition coefficients of particular COCs and their solubilization in cosolvent-surfactant or surfactant systems is important in the evaluation and optimal design of the S-ISCO® process.

The surfactant mixtures in the series can have various HLB value distributions. For example, a surfactant mixture can have a narrow HLB value distribution and can have either high average HLB values, for example 12 to 15, or low average HLB values, for example, 10 to 12. Alternatively, a surfactant-cosolvent mixture can have a broad HLB value distribution with HLB values variable depending on the particular NAPL or sorbed chemical species requiring treatment.

The surfactant mixtures in the series can have various molecular weight distributions. For example, a surfactant mixture can have a narrow molecular weight distribution and can have a low or a high average molecular weight. Alternatively, a surfactant-cosolvent mixture can have a broad molecular weight distribution.

A study included preparation of a series of surfactant-cosolvent mixtures in which the EO/PO ratio and average molecular weight were varied for different COCs (Diallo et al. (1994)). Batch testing was performed on the ability of a surfactant-cosolvent mixture to solubilize a hydrocarbon, e.g., a contaminant targeted for remediation. It was observed that as the HLB of the surfactant increased that the solubilization of COC increased through a maximum, then decreased as the HLB further increased.

Thus for a given molecular contaminant species there is an optimal value of HLB for the surfactant to solubilize it. For a distribution of contaminant molecules there is an optimal distribution of HLB values. Thus, an aspect of the method presented here is determining an optimal surfactant or cosolvent-surfactant mixture, based on the HLB for which solubilization is maximized for subsequent or simultaneous oxidation of the solubilized species. An advantage of this approach is that, should circumstances require, e.g., a change in government regulations or cost of a particular surfactant, a different surfactant having a similar HLB can be substituted for a surfactant in a treatment composition.

The ability to tailor the EO/PO ratio and the molecular weight distribution of molecules in the surfactant-cosolvent mixture and thereby adjust the HLB of the surfactant allows the surfactant-cosolvent mixture to be optimized for a targeted contaminant and for sequential or simultaneous oxidation.

The transport properties of the surfactant or surfactant-cosolvent mixture in the soil of the site to be remediated can also be tested, for example, in soil-column tests. Characteristics of the soil, for example, surface chemistry, clay minerology, and/or pH may affect the transport properties of the surfactant or surfactant-cosolvent mixture through the soil. The results of testing of transport properties, or observations of transport properties in the field of the surfactant or surfactant-cosolvent mixture may indicate further tailoring of the hydrophilic characteristics of the surfactant. It may be indicated to trade-off some of the desired solubilization characteristics for required transport characteristics in developing a surfactant or surfactant-cosolvent mixture that is optimal for the site to be remediated.

### Testing of Compositions for Injection

Testing of OMS and/or oxidants, surfactants, cosolvents and/or solvents can be conducted with the contaminant in the non-aqueous phase and/or sorbed phase in aqueous solution, or with the contaminant in a soil slurry or soil column. A soil slurry or soil column can use a standard soil or actual soil from a contaminated site. An actual soil can be homogenized for use in a soil slurry or soil column. Alternatively, an intact soil core obtained from a contaminated site can be used in closely simulating the effect of introduction of oxidant, surfactant, and/or solvent for treatment.

Testing of OMS and/or oxidants, surfactants, cosolvents, and/or solvents can be conducted with the contaminant in a batch experiment, with or without soil.

The range of quantity of surfactant that can form a Winsor I, II, or III system or a microemulsion in the subsurface can be identified.

Various techniques can be used in conjunction with surfactant enhanced in situ chemical oxidation (S-ISCO) treatment, for example, use of macro-molecules or cyclodextrins, steam injection, sparging, venting, and in-well aeration.

An aspect of the control that can be achieved by use of an embodiment of the invention for site remediation is direction of antioxidant to a target region of contaminant. As discussed above, the density of the injected solution can be modified, so that the oxidant reaches and remains at the level in the subsurface of the target region of contaminant. Considering of factors such as subsurface porosity and groundwater flow, the location of wells for injecting solution containing oxidant can be selected so that oxidant flows to the target region of contaminant.

In an embodiment, the consumption of antioxidant is further controlled by including an antioxidant in the injected solution. For example, an antioxidant can be used to delay the reaction of an oxidant. Such control may prove important when, for example, the injected oxidant must flow through a region of organic matter which is not a contaminant and with which the oxidant should not react. Avoiding oxidizing this non-contaminant organic matter may be important to maximize the efficiency of use of the oxidant to eliminate the contaminant. That is, if the oxidant does not react with non-contaminant organic matter, then more oxidant remains for reaction with the contaminant. Furthermore, avoiding oxidizing non-contaminant organic matter may be important in its own right. For example, topsoil or compost may be desirable organic matter in or on soil that should be retained. The anti-oxidants used may be natural compounds or derivatives of natural compounds. By using such natural antioxidants, their isomers, and/or their derivatives, the impact on the environment by introduction of antioxidant chemicals is expected to be minimized. For example, natural processes in the environment may degrade and eliminate natural antioxidants, so that they do not then burden the environment. The use of natural antioxidants is consistent with the approach of using biodegradable surfactants, cosolvents, and solvents. An example of a natural antioxidant is a flavonoid. Examples of flavonoids are quercetin, glabridin, red clover, Isoflavin Beta (a mixture of isoflavones available from Campinas of Sao Paulo, Brazil). Other examples of natural antioxidants that can be used as antioxidants in the present method of soil remediation include beta carotene, ascorbic acid (vitamin C), and tocopherol (vitamin E) and their isomers and derivatives. Non-naturally occurring antioxidants, such as beta hydroxy toluene (BHT) and beta hydroxy anisole (BHA) could also be used as antioxidants in the present method of soil remediation.

### EXAMPLES

### 2,4,6-Trichlorophenol

### EPA Priority Pollutant

2,4,6-trichlorophenol (TCP) is also known as Dowicide 2S, NCI-C02904, Omal, Phenachlor, RCRA waste number F027, 2,4,6-TCP, and 2,4,6-TCP-Dowidice 25 (Montgomery, John H., ed. Groundwater Chemicals Desk Reference, CRC Press LLC, 3^{rd} edn., 2000, pp. 1006-1008). TCP is a U.S. Environmental Protection Agency (EPA) priority pollutant (U.S. Environmental Protection Agency Priority Pollutants. http://www.epa.gov/waterscience/methods/pollutants.htm (accessed May 30, 2010)). TCP is a known animal carcinogen (The Carcinogenic Potency Project, Berkeley Lab. http://potency.berkeley.edukhempages/2,4,6-TRICHLOROPHENOL.html (accessed May 30, 2010)) and a probable human carcinogen (U.S. Environmental Protection Agency Technology Transfer Network. http://www.epa.gov/ttn/atw/hlthef/tri-phen.html (accessed May 30, 2010)). TCP enters the environment as emissions from its manufacture as a biocide (Howard, Philip H. Handbook of Environmental Fate and Exposure Data for Organic Chemicals: Volume I. Large Production and Priority Pollutants, 1989, Lewis Publishers: Chelsea, Mich., pp. 536-544), a wood and glue preservative, and an anti-mildew agent for textiles (Vershueren, Karel. Handbook of Environmental Data on Organic Chemicals, Volume 2, Environmental Protection Magazine Series, Fourth Edition, John Wiley and Sons: New York, Chichester, Weinheim, Brisbane, Singapore, Toronto, pp. 2084-2087). Other routes for TCP contamination include the chlorination of phenol-containing waters, emissions from the combustion of fossil fuels, and incineration of municipal wastes (Howard, Philip H. Handbook of Environmental Fate and Exposure Data for Organic Chemicals: Volume I. Large Production and Priority Pollutants, 1989, Lewis Publishers: Chelsea, Mich., pp. 536-544).

The concentration of TCP in soil may decrease due to biodegradation; however, this is a function of local conditions including temperature, oxygen availability, and the number and type of microorganisms present. Transport will be greater in sandy soils than those where biodegradation will be high and than those with high organic content. In the latter, adsorption is more likely to occur. At the surface, volatilization is also possible. As in soils, TCP in water is subject to biodegradation and adsorption. Photolysis is also likely. Atmospheric losses can occur via wet and dry deposition. Bioaccumulation is significant in Lymnea (snails) and Poecilia (fish) (Howard, Philip H. Handbook of Environmental Fate and Exposure Data for Organic. Chemicals: Volume I. Large Production and Priority Pollutants, 1989, Lewis Publishers: Chelsea, Mich., pp. 536-544). LC₅₀ values for: earthworms (Eisenia fetida) are 5.0 μg/cm² on contact; bluegill sunfish (Cyprinodon variegates) are 320 μg/L at 96 hours; sheepshead minnow (cyprinodont variegates) are 130 ppm at 72 hours; freshwater water flea (daphnia magna) are 85 mg/L at 48 hours; and red killifish are 7.6 mg/L (Montgomery, John H., ed. Groundwater Chemicals Desk Reference, CRC Press LLC, 3^{rd} edn., 2000, pp. 1006-1008.).

### 2,4,6-Trichlorophenol as a Model Contaminant

In addition to the presence of TCP in the environment as a result of its use in a variety of industrial applications, TCP is also used as a model contaminant due to structural similarity to polychlorinated dibenzodioxins (PCDDs) and dibenzofurans (PCDFs). PCDDs and PCDFs are generated primarily from the flue gases of solid waste incinerators and subject to stringent environmental regulations in the US, Western Europe, and Japan due to the serious health effects associated with exposure to these compounds. TCP, although still toxic, is used in lieu of PCDDs and PCDFs and is far less deadly than PCDDs and PCDFs (Lomnicki et al., Applied Catalysis B: Environmental, vol. 46, no. 1, pp. 105-119, 2003).

### Example 1

### Green Synthesis of K-OMS-2

Milli-Q water and analytical grade KMnO₄ from Fisher were the only reagents used to prepare K-OMS-2.

KMnO₄ (1.8 g) was dissolved in 70 mL of distilled deionized water (DDW) and stirred for 30 minutes to form a homogeneous solution which was further transferred into a 125 mL Teflon-lined autoclave for hydrothermal treatment at 240° C. for 4 days. The resultant slurry was washed with DDW to remove any possible impurities. The product was dried in a vacuum oven at 60° C. overnight.

Whereas other synthetic routes involve expensive oxidants and yield unwanted by-products, this synthesis is both green and economic as no hazardous by-products are generated and the manganese is completely transferred to the K-OMS-2.

### K-OMS-2 Characterization

K-OMS-2 was characterized using X-Ray Diffraction (XRD), Transmission Electron Microscopy (TEM), the Brunauer-Emmet-Teller (BET) method for determining surface area, and potentiometric titrations to determine average oxidation state (AOS).

### Powder X-Ray Diffraction

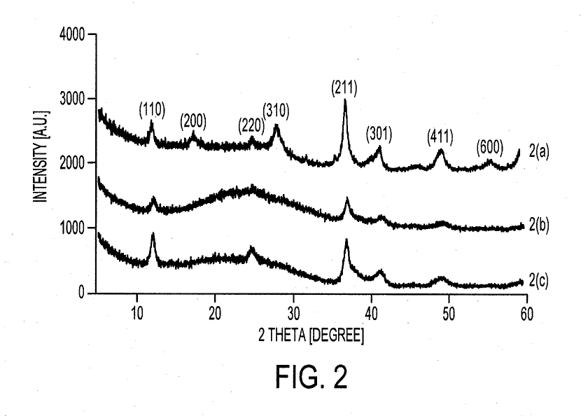

Powder X-Ray Diffraction studies were performed on a Scintag XDS-2000 diffractometer using CuKα (λ=0.15406 nm) radiation. A beam voltage of 45 kV and a 40 mA beam current were used. The data were collected in the 2θ range from 5-60° with a continuous scan rate of 0.5 degrees/minute and the phases identified by using the Joint Committee on Powder Diffraction Society (JCPDS) database. The XRD pattern of K-OMS-2 is shown in FIG. 2.

The disappearance of the (200) and (600) peaks upon sonication clearly indicates a preferred orientation.

### Transmission Electron Microscopy

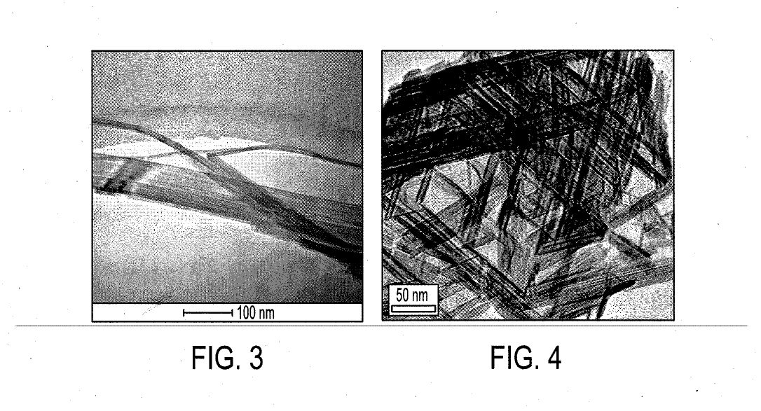

The TEM images shown in FIGS. 3 and 4 were taken on a Tecnai T12 electron microscope. Powder samples were dispersed ultrasonically in 2-propanol. A drop of this solution was deposited on a Quantafoil holey carbon-coated copper grid for analysis.

Upon manipulation of the axes, the striations evident in FIG. 3 remained in the same positions indicating that they are not the result of Moree fringing but rather a unique bamboo morphology. The image in FIG. 4 indicates a preferred orientation that correlates with the XRD results.

### Brunauer-Emmet-Teller Method

The surface area of K-OMS-2 was measured using the Brunauer-Emmett-Teller (BET) method on a Micromeritics ASAP 2010 instrument. The area was determined to be 100 m² g⁻¹ using nitrogen as the adsorbent using the s multipoint method.

BET surface areas for OMS materials range from about 50 to 250 m² g⁻¹ using nitrogen (Suib, Steven L., Journal of Materials Chemistry, vol. 18, pp. 1623-1631, 2008). Thus the value determined for the KOMS-2 described here is typical.

### Average Oxidation State

Average oxidation state of manganese in KOMS-2 was found to be 3.5 using a potentiometric titration described in the literature (Makwana, et al., Catalysis Today, vol. 85, pp. 225-223, 2003). This value is an average of three experiments.

OMS-2 has an average oxidation state for manganese from about 3.8 to 4.0. Thus the oxidation state of manganese here is less than normal which indicates a lower abundance of Mn⁴⁺ (Suib, Steven L., Journal of Materials Chemistry, vol. 18, pp. 1623-1631, 2008).

### Example 2

### Preparation of the TCP Colloid

Pure analytical grade TCP (98%) from Fisher was added to a solution containing the proprietary, nonionic surfactant, VeruSOL-3 Surfactant™, and DDW. The concentrations of the TCP and Verusol-3 surfactant were 1 and 5 g/L, respectively. The solution was then covered with aluminum foil and mixed on a rotary shaker for 72 hours.

### Example 3

2,4,6-Trichlorophenol (TCP) was used as a test contaminant. K-OMS-2 was used as an example OMS. VeruSOL-3 Surfactant™ was used as an example surfactant/cosolvent mixture.

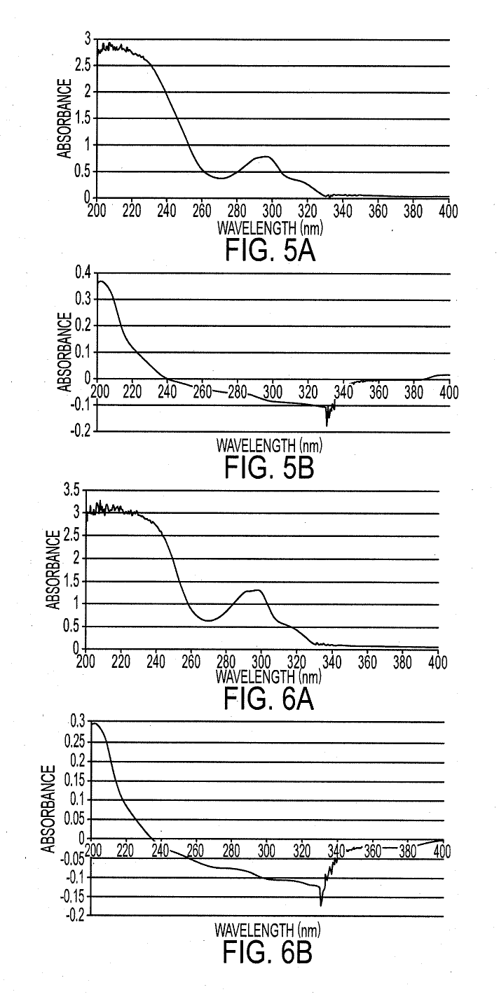

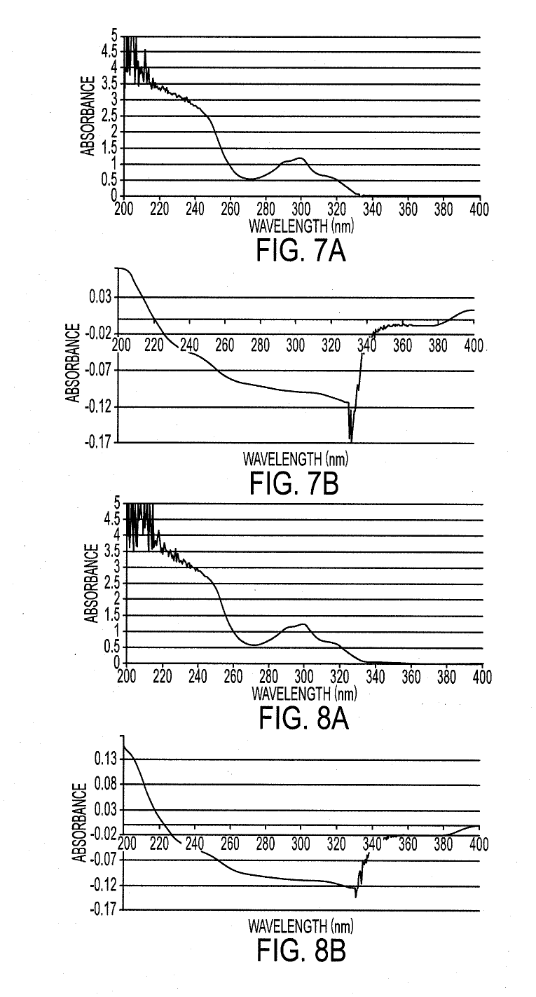

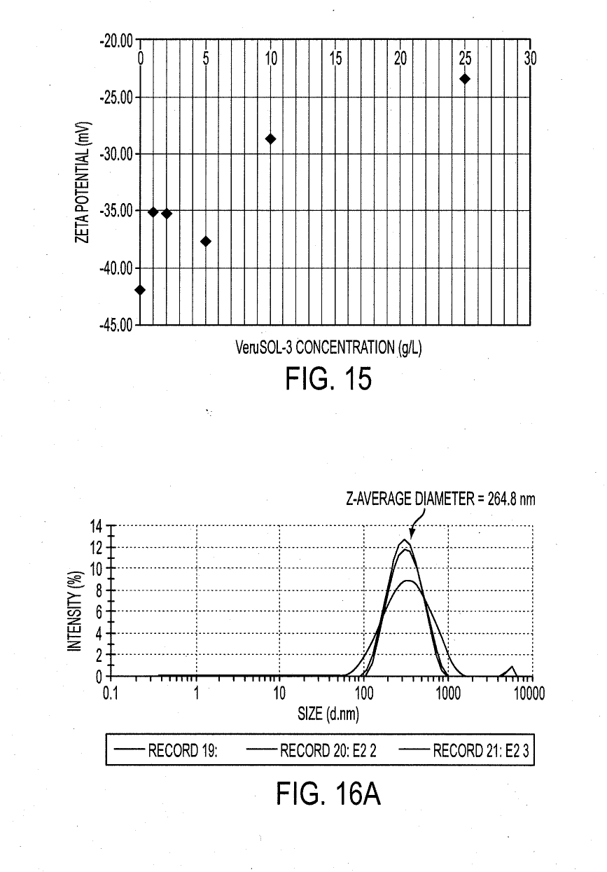

K-OMS-2 was sonicated for 15 minutes in water. TCP was added to a relative concentration of 5 mg K-OMS-2 for every 5 mmol of TCP. TCP was emulsified using Verusol-3 surfactant at varying concentrations. The reactions were shaken for 24 hours. No oxidant other than oxygen from air was added to the reactions. After 24 hours, all TCP had been consumed, as measured by UV-vis spectrophotometry. Initial and final spectra are shown in FIGS. 5-8. VeruSOL surfactant concentrations of 10 g/L are shown in FIGS. 5A and 5B, 15 g/L in FIGS. 6A and 6B, 20 g/L in FIGS. 7A and 7B, and 25 g/L in FIGS. 8A and 8B.

### Example 4

### Degradation of TCP with KOMS-2

K-OMS-2 (3.75 mg) that was sonicated in DDW for 15 minutes was added per 5 mmol of TCP. Aliquots were periodically removed from an amber vial, filtered through a 0.45 micron syringe filter several times, and analyzed for TCP degradation. K-OMS-2 was sonicated in DDW prior to reaction in order to increase dispersion.

### Degradation of TCP

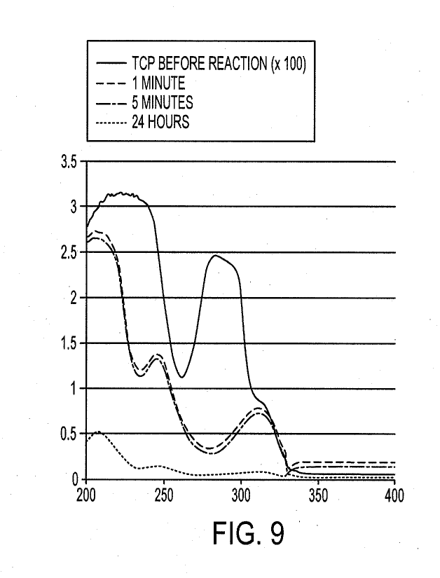

TCP degradation in the aqueous phase was confirmed via optical absorbance measurements on a Jasco V-530 UV-Vis Spectrophotometer. A quartz cell with a path length of 1.0 cm was used for all measurements. FIG. 9 shows the degradation of TCP as a function of time. Note that the spectrum of TCP prior to reaction was diluted 100 times, while reaction samples were not. The intermediate seen at 1 minute and 5 minutes has absorption maxima at 207, 246, and 315 nm. At 24 hours, the first two absorption maxima shifted slightly to 209 and 248 nm. Solutions of p-quinone, hydroquinone, fumaric acid, formic acid, dichlorophenol, dichlorobenzoquinone, 2-chlorocatechol, and 4-chlorobenzaldehyde were made in an attempt to determine the identity of the intermediate. These were chosen based on what was available, on intermediate and on final products from the literature, (Bandara, et al., Applied Catalysis B: Environmental, vol. 34, pp. 321-333, 2001; Lomnicki, et al., Applied Catalysis B: Environmental, vol. 46, no. 1, pp. 105-119, 2003) and on likely chemicals as determined by functional groups that exist at the known wavelengths (Pretsch, et al., Structure Determination of Organic Compounds Tables of Spectral Data. 4^{th} Edition. Springer-Verlag Berlin Heidelberg, Chapter 9: UV/Vis Spectroscopy, p. 401-420,2009). In addition, numerous injections of the intermediate, after washing with either methylene chloride or chloroform, into an HP 5890 Series II gas chromatograph equipped with an HP 5971 mass selective detector coupled with a thermal conductivity detector using a nonpolar (HP-1) column, indicated that no intermediate was present.

Determination of the order of reaction was not possible as the intermediate appeared as soon as the reaction was initiated. That is, by the time an aliquot was withdrawn and filtered, the intermediate had formed. Rate of formation of the intermediate was not determined as its identity is unknown. None of the solutions made (p-quinone, hydroquinone, fumaric acid, formic acid, dichlorophenol, dichlorobenzoquinone, 2-chlorocatechol, or 4-chlorobenzaldehyde) replicated the absorption spectrum of the unknown. It is possible that the intermediate is an aromatic complexed with Mn³⁺ which would cause a bathochromic shift in the π-π* transition making identification more difficult (McBride, M. B., Clays and Clay Minerals, vol. 37, pp. 479-486, 1989).

Gas chromatography was complicated by the use of water as a reaction medium. As the identity of the intermediate is unknown, it was difficult to determine the appropriate solvent to use for extraction. Methylene chloride and chloroform were chosen as a function of TCP solubility; however, the intermediate may not be soluble in either of these. It is also possible that the intermediate was at a concentration too low to be detected by the GC-MS; however, it is undesirable to increase the initial concentration of TCP as the use of higher concentrations leads to bimolecular coupling reactions that are not relevant to environmental conditions (Lipczynska-Kochany, et al., Environmental Science and Technology, vol. 26, pp. 259-262, 1992). Ukrainczyk and McBride proposed a mechanism involving formation of an inner sphere surface complex between phenolate and manganese, followed with nucleophilic aromatic substitution by addition-elimination to account for dechlorination and oxidation (Ukrainczyk, et al., Environmental Toxicology and Chemistry, vol. 12, pp. 2015-2022, 1993). Ferrari, Laurenti, and Trotta proposed an oxidative dechlorination pathway yielding 1,4-benzoquinone involving an intermediate phenoxy radical followed by a nucleophilic attack by water on the 2,4,6-trichlorocyclohexadienone cation at position 4. This would yield 2,4,6-trichloro-4-hydroxy-cyclohexadienone which would eliminate HCl to give 1,4-benzoquinone. Similar to our findings, Ferrari, Laurenti, and Trotta found that TCP was completely converted to product in one minute. However, whereas our product continued to decrease through 24 hours until the UV-Vis spectrum no longer contained clear peaks, Ferrari, Laurenti, and Trotta found that their product concentration remained constant for approximately 24 hours (Ferrari, et al., Journal of Biological Inorganic Chemistry, vol. 4, pp. 232-237, 1999). Competitive oxidative pathways of substituted phenols include deprotonation, phenoxy radical formation, coupling of phenoxy radicals, phenoxenium ion formation, hydrolysis and benzoquinone formation, and electrophilic attack by phenoxenium ions (Stone, et al., Environmental Science and Technology, vol. 21, pp. 979-988, 1987).

Analysis of Sorption onto the Catalyst

K-OMS-2 was centrifuged out of solution following degradation of TCP and dried in a desiccator at room temperature for three days. Fourier Transform Infrared Spectroscopy (FTIR) spectra were collected using a Nicolet Magna-IR 750 FTIR spectrometer with a DTGS detector, cooled by liquid nitrogen. Samples were diluted with KBr at a ratio of 1:100 and then pressed into pellets at about 10,000 psi. The spectral background was collected with pure KBr discs.

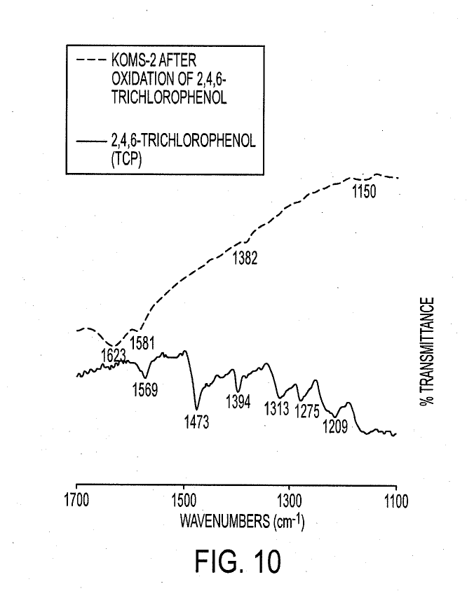

FTIR experiments were run to analyze the K-OMS-2 following the degradation reaction of TCP for sorption of TCP or any partially oxidized species. FIG. 10 illustrates the results of these experiments.

Following oxidation of TCP, peaks on the K-OMS-2 at 1623 (Lomnicki, et al., Applied Catalysis B: Environmental, vol. 46, no. 1, pp. 105-119, 2003), 1581 (The Handbook of Infrared and Raman Characteristic Frequencies of Organic Molecules. Academic Press Inc. 1991. p. 280-281), and 1382 (Kung, et al., Environ. Sci. Technol., vol. 25, pp. 702-709, 1991) cm⁻¹. are consistent with the CC stretching vibrations of a dihydroxybenzene species, while the peak at 1150 cm⁻¹ (The Handbook of Infrared and Raman Characteristic Frequencies of Organic Molecules. Academic Press Inc. 1991. p. 282-283) is associated with a semicircle stretch mixed with in-plane C—H bending in a 1,2-di-substituted benzene. These data indicate that the partial oxidation product adsorbed to K-OMS-2 is 1,2-dihydroxybenzene. This is novel in that a partial oxidation product versus TCP is adsorbed to the solid. Previous work done with manganese oxides (Ukrainczyk, et al., Environmental Toxicology and Chemistry, vol. 12, pp. 2005-2014, 1993), goethite and noncrystalline iron oxide (Kung, et al., Environmental Science & Technology, vol. 25, pp. 702-709, 1991), and α-Fe₂O₃ (Bandara, et al., Applied Catalysis B: Environmental, vol. 34, pp. 307-320, 2001) indicated only adsorption of TCP. Chemisorption is likely as washing with DDW did not change the spectra. The characteristic TCP peaks at 1569, 1473, 1394, 1275, and 1209 cm⁻¹ are no longer present and the spectrum does not contain common features associated with the chemisorption of TCP (Ukrainczyk, et al. Environmental Toxicology and Chemistry, vol. 12, pp. 2005-2014, 1993).

### Example 5

### Heating Oil Degradation with KOMS-2

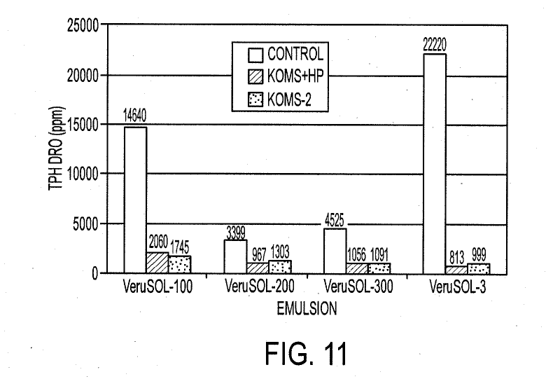

Heating oil was emulsified with various concentrations and composition of surfactants and surfactant-cosolvent mixtures. These surfactant and surfactant-cosolvent mixture are known as VeruSOL-100, VeruSOL-200, VeruSOL-3 surfactant 00 and VeruSOL-3 surfactant. Surfactants and surfactant-cosolvent mixtures were added at 1 g/L to 3 L of deionized water with 5 g/L of heating oil NAPL added. The emulsions were mixed at 150 rpm for 3 days prior to adding either KOMS-2 alone at 150 mg/L or 8 percent hydrogen peroxide with 150 mg/L as a catalyst. The KOMS-2 alone reactors were reacted for 14 days and were shaken at 150 rpm on an orbital shaker table. The hydrogen peroxide reactors with KOMS-2 added as a catalyst were reacted for 5 days and were shaken at 150 rpm on an orbital shaker table. After the appropriate time period the reactors were stopped and the solution was tested for Total Petroleum Hydrocarbons Diesel Range Organics (TPH/DRO) with a SiteLab UVF-3100 Fluorescence Spectrophotomter, following hexane extraction, equivalent to USEPA Method 8015B. Control reactors were run for each of the surfactant or surfactant-cosolvent mixtures being oxidized. Results of these tests, as shown in FIG. 11, indicates that in comparison to control reactors there was significant destruction of TPH DRO in each of the surfactant- or surfactant-cosolvent-heating oil mixtures for both KOMS-2 alone and hydrogen peroxide with KOMS-2 added as a catalyst. The actual TPH/DRO concentration in the control after 14 days varies depending on the specific surfactant or surfactant-emulsion mixture used to initially emulsify the heating oil. VeruSOL100 and Verusol-3 surfactant solubilized the highest concentration of TPH/DRO from the heating oil. The greatest destruction of emulsified heating oil in comparison to the 14 day control TPH/DRO concentration was observed with the Verusol-3 surfactant solubilized heating oxidized with the hydrogen peroxide-KOMS-2 combination where the control concentration of TPH/DRO was 22,220 mg/L and the treated concentration was 813 mg/L with a 96.3 percent destruction effectiveness. However, KOMS-2 alone resulted in a final treated TPH/DRO concentration of 999 mg/L resulting in a 95.5 percent destruction effectiveness. The comparative results of KOMS-2 alone illustrates the effectiveness in the destruction of emulsified heating oil without the use of a strong oxidant, a significant benefit of OMS.

### Example 6

### Surfactant Adsorbed KOMS-2 Particles

### Effects of Verusol-3 Surfactant on KOMS-2 Properties

The presence of Verusol-3 surfactant in solution without KOMS-2 acts to reduce interfacial tension and allows the emulsification of immiscible non aqueous phase liquids enabling destruction by compounds such as KOMS-2 (S-ISCO®, described in U.S. Pre-Grant Publication 2008/0207981). But, the behavior of VeruSOL-3 surfactant is not limited to transferring a less reactive immiscible organic liquid (i.e., a Non Aqueous Phase Liquid or NAPL) to an aqueous phase where compounds such as KOMS-2 can destroy the emulsified immiscible organic liquid.

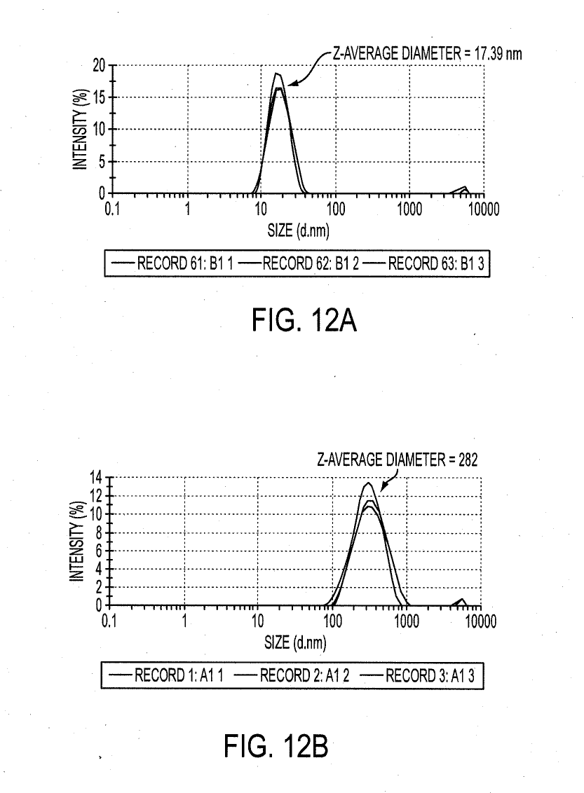

Verusol-3 surfactant is adsorbed onto the surface of OMS when VeruSOL-3 surfactant is added to a solution containing KOMS-2 particles. Verusol-3 surfactant in solution at 5 g/L exhibits mean particle size of 17.03 nm with a standard deviation of 2.53 nm (5 replicate runs, each with triplicate analyses, FIG. 12A). The zeta potential of VeruSOL-3 surfactant in solution at 5 g/L is −20.22 mV with a standard deviation of 5.32 mV (5 replicate runs, each with triplicate analyses). A 0.556 g/L solution of KOMS-2 has a mean particle size of 284.04 nm with a standard deviation of 1.26 nm (5 replicate runs, each with triplicate analyses, FIG. 12B). The zeta potential of KOMS-2 in solution at 0.556 g/L is −41.92 mV with a standard deviation of 16.46 mV (5 replicate runs, each with triplicate analyses, Table 1). Comparison of the zeta potential of the KOMS-2 and the Verusol-3 surfactant solutions indicate that the VeruSOL-3 surfactant is a moderately stable colloidal suspension and the KOMS-2 is an extremely stable colloidal suspension. The difference between the zeta potential of the KOMS-2 and the VeruSOL-3 surfactant solutions are significant, with the zeta potentials of the 5 g/L solution VeruSOL-3 surfactant equal to −20.22 mV and the 0.556 g/L KOMS-2 solution equal to −41.92 mV. Similarly the mean particle sizes of the 5 g/L solution VeruSOL-3 surfactant (17.03 nm) is significantly different from the 0.556 g/L KOMS-2 solution (284.04 nm).

TABLE 1
Particle Size Distributions and Zeta Potential of VeruSOL-3
surfactant - KOMS-2 Mixtures

| VeruSOL-3 surfactant | | | |
|---|---|---|---|
| Concentration | Z-Average | VeruSOL-3 surfactant | Zeta |
| with 0.556 g/L | Diameter | Concentration with | Potential |
| KOMS-2 (g/L) | (nm) | 0.556 g/L KOMS-2 (g/L) | (mV) |
| 0 | 284.04 | 0 | −41.92 |
| 1 | 307.64 | 1 | −35.14 |
| 2 | 296.92 | 2 | −35.22 |
| 5 | 315.66 | 5 | −37.66 |
| 10 | 320.18 | 10 | −28.68 |
| 25 | 342.42 | 25 | −23.40 |

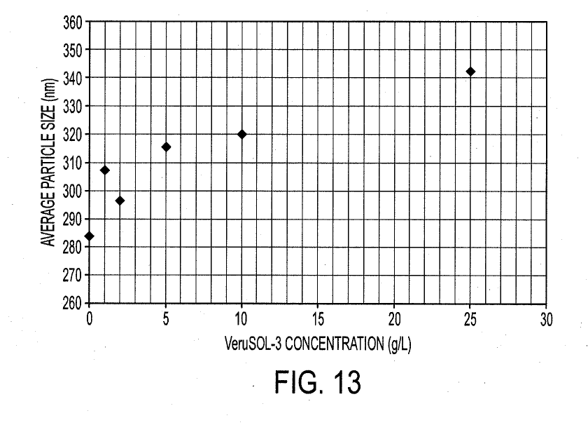

Unexpectedly, when colloidal suspensions of Verusol-3 surfactant are added to KOMS-2 colloidal suspensions, adsorption of the Verusol-3 surfactant takes place onto the KOMS-2 particles, modifying the properties of the resultant colloidal suspension. Experiments were conducted where various concentrations of VeruSOL-3 surfactant were added to individual colloidal suspensions of KOMS-2 at a constant KOMS-2 concentration of 0.556 g/L. Particle size distributions and zeta potentials were measured of the resultant solutions which are shown in Table 1. It is evident that the addition of increasing concentrations of Verusol-3 surfactant added to 0.556 g/L KOMS-2 colloidal suspensions increased the mean particle size of the KOMS-2. For example, a 0.556 g/L KOMS-2 solution without VeruSOL-3 surfactant was observed to have a 284.04 nm mean particle size and a 0.556 g/L KOMS-2 solution with 5 g/L Verusol-3 surfactant also in the suspension resulted in a mean particle size of 315.66 nm. The relationship between mean particle size and Verusol-3 surfactant concentration can be seen in FIG. 13. Despite the fact that a 5 g/L Verusol-3 surfactant solution has mean particle sizes of 17.03 nm, and slightly smaller mean particle sizes with increasing Verusol-3 surfactant concentrations in water, the mean particle size of the Verusol-3 surfactant and KOMS-2 mixtures become larger. This adsorption of Verusol-3 surfactant onto KOMS-2 and resultant particle coating with Verusol-3 surfactant is through a hydrophobic bonding mechanism. The hydrophobic portion of the Verusol-3 surfactant molecules are highly attracted to the hydrophobic KOMS-2 particles.

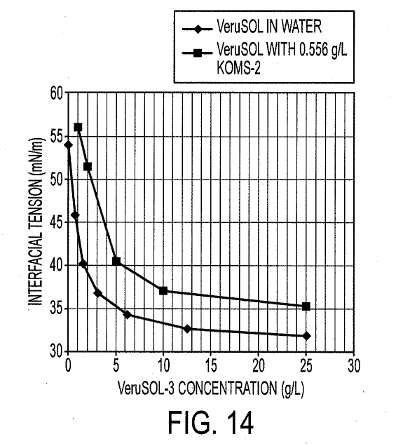

Further evidence of the adsorption of Verusol-3 surfactant onto KOMS particles in solution can be seen from the effects on Interfacial Tension (IFT) measurements made of Verusol-3 surfactant solutions in water with and without KOMS-2 particles. The effects on Verusol-3 surfactant added to KOMS-3 particles, in comparison to Verusol-3 surfactant particles alone, on IFT measurements, is shown in FIG. 14. When KOMS-2 colloidal particles are present with VeruSOL-3 surfactant, there are increases in IFT measurement in comparison to Verusol-3 surfactant alone. This is further evidence that the hydrophobic bonding of Verusol-3 surfactant with the KOMS-2 particles affects the ability of Verusol-3 surfactant to decrease IFT of solutions.

Additional effects of Verusol-3 surfactant coated KOMS-2 are evidenced on the zeta potential (colloid stability) of the resultant Verusol-3 surfactant coated KOMS-2 mixtures, as shown in FIG. 15. It can be seen that increasing Verusol-3 surfactant concentrations with KOMS-2 particles, results in a decrease in the zeta potential and a decrease in the stability of the suspensions. While there is a decrease in the stability of the Verusol-3 surfactant—KOMS-2 suspensions with increasing Verusol-3 surfactant concentrations, the resultant suspensions maintain adequate stability to be stay in suspension and to be transported through soils. The zeta potential of Verusol-3 surfactant alone in water at 5 g/L is −20.2 mV. In comparison to the measured zeta potential of −37.66 mV in a 5 g/L Verusol-3 surfactant mixture containing 0.556 g/L KOMS-2, the difference in zeta potential the result of the presence of KOMS-2 with Verusol-3 surfactant is great.

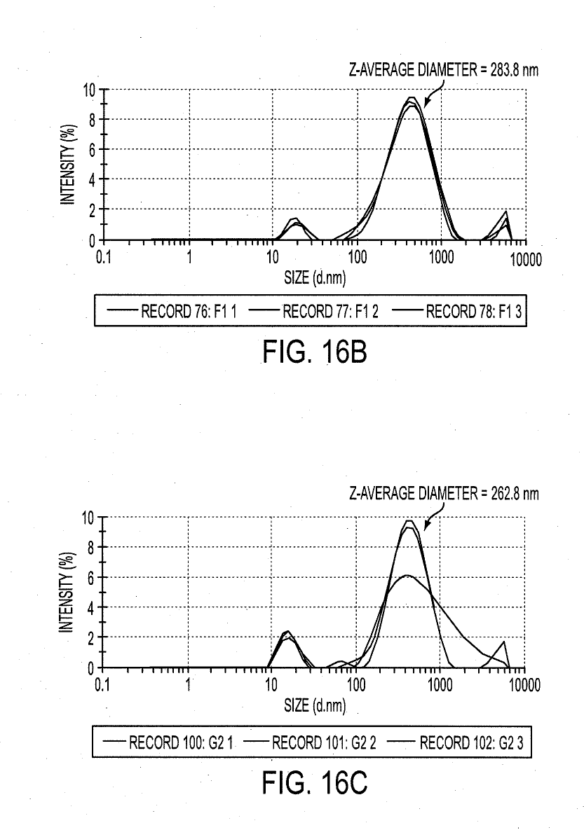

Generally, adsorption of a sorbate (VeruSOL-3 surfactant) on a sorbent (KOMS-2) will reach a saturation depending on the particular type sorbate and sorbent. Using a Malvern Zetasizer Nano ZS, particle size distributions of colloidal suspensions were obtained for Verusol-3 surfactant alone, KOMS-2 alone and various concentrations of Verusol-3 surfactant with KOMS-2. Representative particle size distributions of these colloidal suspensions are shown in FIGS. 12 and 16. It can be seen that the Verusol-3 surfactant and KOMS-2 alone particle size distributions are quite different with KOMS-2 more than 20 times larger than Verusol-3 surfactant (FIGS. 12A and 12B). When up to 5 g/L Verusol-3 surfactant is added to the KOMS-2 colloidal suspension there are no Verusol-3 surfactant particles in the 10 to 20 nm size range, as they are sorbed onto the KOMS-2 (FIG. 16A). However, at 10 g/L and 25 g/L Verusol-3 surfactant concentrations added to KOMS-2, it is evident that sorption sites on the KOMS-2 have been saturated and excess Verusol-3 surfactant appears in the particle size distribution graphs (FIGS. 16B and 16C, respectively). It should be noted that the Z-Average statistic averages all particle sizes that exist in the colloidal suspensions. It can be seen from examination of the larger Verusol-3 surfactant coated KOMS-2 peaks that the particle sizes of the Verusol-3 surfactant coated KOMS-2 peaks are larger than the Z-Average statistic when multiple peaks are present, particularly for the 10 g/L and 25 g/L Verusol-3 surfactant with KOMS-2 suspensions. The actual diameter of the KOMS-2 coated particles for the 0 g/L, 1 g/L, 2 g/L, 5 g/L, 10 g/L and 25 g/L Verusol-3 surfactant coating KOMS-2 colloidal suspensions are 318.4 nm, 357.1 nm, 357.0 nm, 380.9 nm, 451.1 nm and 441.1 nm, respectively. It is apparent that the particle size increase of the Verusol-3 surfactant coated KOMS-2 particles stabilizes approximately between 440 nm and 450 nm, once Verusol-3 surfactant sorption sites are saturated.

### Discussion

Surface coating of Verusol-3 surfactant on KOMS-2 provides unexpected benefits not realized with KOMS-2 alone. A surfactant-cosolvent coating provided by Verusol-3 surfactant enables the benefits of micellularization of NAPLs (creation of NAPL-Verusol-3 surfactant micelles) in an oil-in-water colloidal suspension with the presence of KOMS-2 in the micelle matrix. This enables microemulsion catalysis whereby the NAPL is micellularized and the oxidative destruction by KOMS-2 reactions are facilitated in the same KOMS-2-Verusol-3 surfactant particle suspension matrix.

Additionally, during KOMS-2 synthesis, additional inorganic chemicals can be added to KOMS-2 and may increase the catalytic activity of KOMS-2 alone or when KOMS-2 is added as an activator or catalyst to chemical oxidants, such as hydrogen peroxide, sodium, potassium, or ammonium persulfate, peracetic acid or calcium peroxide. Inorganic chemical species may include transition or noble metals, such as iron or iron oxides, titanium or titanium oxides, copper, nickel, gold, silver, palladium, or platinum, or combinations thereof.

An additional benefit of providing an adsorbed Verusol-3 surfactant coating on KOMS-2 particles is that it reduces soil mineral/KOMS-2 sorption reactions, increasing transport of KOMS-2 in soils more than possible with KOMS-2 alone. A benefit of adding a Verusol-3 surfactant coated KOMS-2 catalyst, either Verusol-3 surfactant coated KOMS-2 or Verusol-3 surfactant coated KOMS-2 impregnated with additional inorganic compounds, to an oxidant being injected into the subsurface for remediation, is that catalyst and NAPL micelluralizing agents can be added in a unitary mixture and that the catalyst has a protective Verusol-3 surfactant coating that reduces catalyst interactions with the surrounding mineral matrix of the subsurface soil.

As described herein, all embodiments or subcombinations may be used in combination with all other embodiments or subcombinations, unless mutually exclusive.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A method for reducing the amount of a contaminant in a contaminated medium, comprising combining manganese-based octahedral molecular sieves with the medium under conditions effective to degrade the contaminant, wherein the contaminated medium comprises solid material and the sieves are introduced to the medium, or the contaminated medium comprises fluid and the sieves are incorporated into a solid reactive barrier that is contacted by the medium.

2. The method of claim 1, wherein the contaminant is a non-aqueous phase liquid.

3. The method of claim 1, wherein the medium comprises soil.

4. The method claim 1, further comprising combining an oxidant with the medium.

5. The method of claim 5, wherein the oxidant is a persulfate or peroxide compound.

6. The method of claim 7, wherein the oxidant is a persulfate compound and the manganese-based octahedral molecular sieves activate the persulfate or peroxide compound to produce free radicals.

7. The method of claim 1, wherein the manganese-based octahedral molecular sieves are incorporated into a solid reactive barrier.

8. The method of claim 1, comprising introducing a surfactant and/or cosolvent into the medium.

9. The method of claim 1, wherein the contaminated medium comprises solid material and contaminated fluid, and the manganese-based octahedral molecular sieves are introduced to the medium.

10. The method of claim 8, wherein the surfactant and/or cosolvent coats the surface of, or is adsorbed to the surface of the manganese-based octahedral molecular sieves.

11. The method of claim 1, wherein the manganese-based octahedral molecular sieves are K-OMS-2.

12. The method of claim 1, wherein the manganese-based octahedral molecular sieves comprise an additional metal cation within the molecular framework.

13. A composition comprising manganese-based octahedral molecular sieves and a surfactant and/or cosolvent, wherein the manganese-based octahedral molecular sieves are coated with the surfactant or surfactant-cosolvent mixtures, the composition being effective to form a mutually compatible combination with a medium containing contaminant, and to oxidize the contaminant.

14. The composition of claim 13, wherein the manganese-based octahedral molecular sieves are K-OMS-2.

15. The composition of claim 13, wherein the manganese-based octahedral molecular sieves comprise an additional metal cation within the molecular framework.

16. The composition of claim 13, wherein the surfactant and/or cosolvent is biodegradable and/or plant derived.

17. The composition of claim 13, wherein the surfactant and/or cosolvent is selected from the group consisting of a carboxylate ester, a plant-based ester, a terpene, a citrus-derived terpene, limonene, d-limonene, and combinations.

18. The composition claim 13, wherein the surfactant and/or cosolvent is selected from the group consisting of castor oil, cocoa oil, cocoa butter, coconut oil, soy oil, tallow oil, cotton seed oil, a naturally occurring plant oil, a plant extract, and combinations.

19. The composition of claim 13, wherein the surfactant and/or cosolvent is selected from the group consisting of a nonionic surfactant, ethoxylated soybean oil, ethoxylated castor oil, ethoxylated coconut fatty acid, amidified, ethoxylated coconut fatty acid, an alkyl polyglucoside or an alkyl polyglucoside-based surfactant, a decyl polyglucoside or an alkyl decylpolyglucoside-based surfactant, and combinations.

20. A composition comprising:
Manganese-based octahedral molecular sieves;
at least one citrus terpene; and
at least one nonionic surfactant selected from the group consisting of ethoxylated soybean oil, ethoxylated castor oil, ethoxylated coconut fatty acid, and amidified, ethoxylated coconut fatty acid; and
water,
the combination being effective to form a mutually compatible combination with a medium containing contaminant, and to oxidize the contaminant.
